(19) United States
(12) Patent Application Publication
(10) Pub. No.: US 2026/0089797 A1
(43) Pub. Date: Mar. 26, 2026

(54) DYNAMIC IMPLEMENTATION OF UNIFIED DATA STORAGE FUNCTION-BASED DATA RETRIEVAL FOR USER EQUIPMENT IN EXTENDED DISCONTINUOUS RECEPTION AND MOBILE INITIATED CONNECTION ONLY MODES

(71) Applicant: DISH Wireless L.L.C., Englewood, CO (US)

(72) Inventors: Borong Zheng, Vaughan (CA); Mohammad Dawood Shahdad, Aurora, CO (US); Sundeep Goswami, Leesburg, VA (US)

(21) Appl. No.: 18/889,144

(22) Filed: Sep. 18, 2024

(51) Int. Cl. H04W 76/28; H04L 67/568

(52) U.S. Cl. CPC H04W 76/28; H04L 67/568

(57) ABSTRACT

An apparatus comprises a memory and a processor communicatively coupled to one another. The processor may be configured to communicate a request to deliver downlink data to one or more user devices in one or more communication operations, associate the request to deliver the downlink data with a unified data storage function (UDSF), determine whether a communication link is established between one or more network components hosting the UDSF and the one or more user devices based at least in part upon one or more access commands, cache the downlink data in the UDSF in response to determining that the communication link is not established, and transmit the downlink data to the one or more user devices in response to determining that the communication link is established.

### TECHNICAL FIELD

The present disclosure relates generally to recover communication operations in a network, and more specifically to a system and method to dynamically implement unified data storage function (UDSF)-based data retrieval for user equipment in extended discontinuous reception (eDRX) and mobile initiated connection only (MICO) modes.

### BACKGROUND

In some wireless communications systems, network functions may be configured to transfer data between one or more network components. Some network functions may be configured to transfer data to user devices from the network components. In situations where the user devices are not available to receive the data, these network functions may be configured to periodically attempt to transfer the data until the user devices become available.

As part of these operations, the network functions use several network resources each time and an attempt to reach the user devices is made. In each unsuccessful attempt, the network resources used by the network functions may be wasted over time.

### SUMMARY OF THE DISCLOSURE

In one or more embodiments, the system and method disclosed herein improve downlink communication operations. In this regard, the system and method described herein provide several practical applications and technical advantages that overcome current technical problems in wireless communication technology. In particular, the system and method are integrated into multiple practical applications improving speed, quality, and reliability of wireless communications systems. The system and method may be configured to provide a smart mechanism to manage and deliver downlink data in wireless communication networks. In some embodiments, wireless communication systems comprise one or more network components configured to host and/or perform specific Network Functions (NFs) in the wireless communication network. The wireless communication network may comprise a Service-Based Architecture (SBA). Further, each network component may be configured to perform multiple communication transmissions across the wireless communication network in accordance with routing and configuration information provided by a specific network component communicating in a transfer network. The system may be configured to efficiently manage and deliver downlink data in wireless communication networks by integrating a Unified Data Storage Function (UDSF) hosted and/or performed by one or more network components into one or more communication operations comprising downlink data. Herein, the UDSF is configured to deliver downlink data for communication operations in cellular internet-of-things using service-based interfaces (SBI) to bypass several communication operations performed by other NFs. The SBIs may be interfaces configured to communicatively couple one or more network components configured to host and/or perform one or more NFs. Further, the SBIs may be one or more interfaces defined in technical specifications of the 3GPP standards.

In one or more embodiments, the system described herein is integrated into a practical application of dynamically delivering downlink data for communication operations in cellular internet-of-things (CIoT). In particular, the system may be configured to time delivery of downlink data with active times of user devices configured to perform IoT operations. The UDSF is configured to store various types of data required by network functions, such as mobile downlink data and session state data while UEs are unavailable. In this regard, the system may be configured to inhibit NFs from repeatedly attempt to deliver downlink data to idle and/or disconnected user devices. Further, the system is integrated into a practical application of reducing a number of communication operations performed to deliver downlink data from a core network to one or more user devices. The system may be configured to integrate the UDSF into downlink communication operations to inhibit other NFs from using resources to coordinate and prepare delivery of downlink data to the user devices. Herein, the system is configured to use the UDSF to efficiently manage caching and just-in-time delivery of downlink data while reducing network signaling, improving scalability of downlink communication operations, and enhancing reliability of downlink communication operations in power-saving modes.

In one or more embodiments, the system described herein is integrated into a technical advantage of increasing processing speeds in a computer system, because processors associated with the system is configured to inhibit multiple NFs from performing redundant downlink communication operations. Herein, the redundant downlink communication operations may be downlink communication operations performed by an access and mobility management function (AMF), where this NF periodically attempts to deliver machine terminated (MT) downlink data to user devices in idle and/or disconnected modes. The system may be configured to eliminate, inhibit, and/or reduce these redundant operations by configuring the UDSF to cache downlink data while user devices are unresponsive, dynamically determine user devices in active modes, and delivering cached data in bulk downlink communication operations to the user devices. In some embodiments, the system is integrated into a technical advantage of reducing memory usage by integrating the UDSF into operation flows configured to time deliveries of downlink data to the user devices. In particular, because the UDSF is configured to cache and time delivery of cached data, memory usage is eliminated, inhibited, and/or reduced at network components previously configured to host and/or perform NFs configured to hold and transmit downlink data to user devices. To this point, integration of the UDSF in downlink communication operations between the core network and the user devices improves functionality of computer systems because the system is configured to eliminate, inhibit, and/or reduce usage of network resources (e.g., processing resources, memory resources, power resources, and the like) by inhibiting the AMF to perform one or more downlink communication operations with user devices in extended discontinuous reception (eDRX) and/or mobile initiated connection only (MICO) modes.

In one or more embodiments, the system and the method may be performed by an apparatus, such as a server, communicatively coupled to multiple network components in a core network, one or more base stations in a radio access network, and one or more user equipment. Further, the system may be a wireless communication system, which comprises the apparatus. In addition, the system and the method may be performed as part of a process performed by the apparatus communicatively coupled to the network components in the core network. As a non-limiting example, the apparatus may comprise a memory and a processor communicatively coupled to one another. The memory may be operable to store one or more access commands comprising guidelines to establish one or more communication links. The processor may be configured to communicate a request to deliver downlink data to one or more user devices in one or more communication operations, associate the request to deliver the downlink data with a unified data storage function (UDSF), determine whether a communication link is established between one or more network components hosting the UDSF and the one or more user devices based at least in part upon the one or more access commands, cache the downlink data in the UDSF in response to determining that the communication link is not established between the one or more network components hosting the UDSF and the one or more user devices in accordance with the one or more access commands, and transmit the downlink data to the one or more user devices in response to determining that the communication link is established between the one or more network components hosting the UDSF and the one or more user devices in accordance with the one or more access commands.

Certain embodiments of this disclosure may comprise some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example communication system in accordance with one or more embodiments;

FIG. 2 illustrates examples of one or more communication operations performed in conjunction with the example communication system of FIG. 1;

FIG. 3 illustrates an operation flow to dynamically delivery downlink data for user plane (UP) Cellular Internet-of-Things (CIoT), in accordance with one or more embodiments;

FIG. 4 illustrates an example flowchart of a method to dynamically delivery downlink data for UP CIoT in conjunction with the communication operations of FIG. 3;

FIG. 5 illustrates an operation flow to dynamically delivery downlink data for control plane (CP) Cellular Internet-of-Things (CIoT), in accordance with one or more embodiments;

FIG. 6 illustrates an example flowchart of a method to dynamically delivery downlink data for CP CIoT in conjunction with the communication operations of FIG. 5;

FIGS. 7A and 7B illustrate operation flows to dynamically implement unified data storage function (UDSF)-based data retrieval for user equipment in extended discontinuous reception (eDRX) and mobile initiated connection only (MICO) modes, in accordance with one or more embodiments; and

FIG. 8 illustrates an example flowchart of a method to dynamically implement UDSF-based data retrieval for user equipment in eDRX and MICO modes in conjunction with the communication operations of FIGS. 7A and 7B.

### DETAILED DESCRIPTION

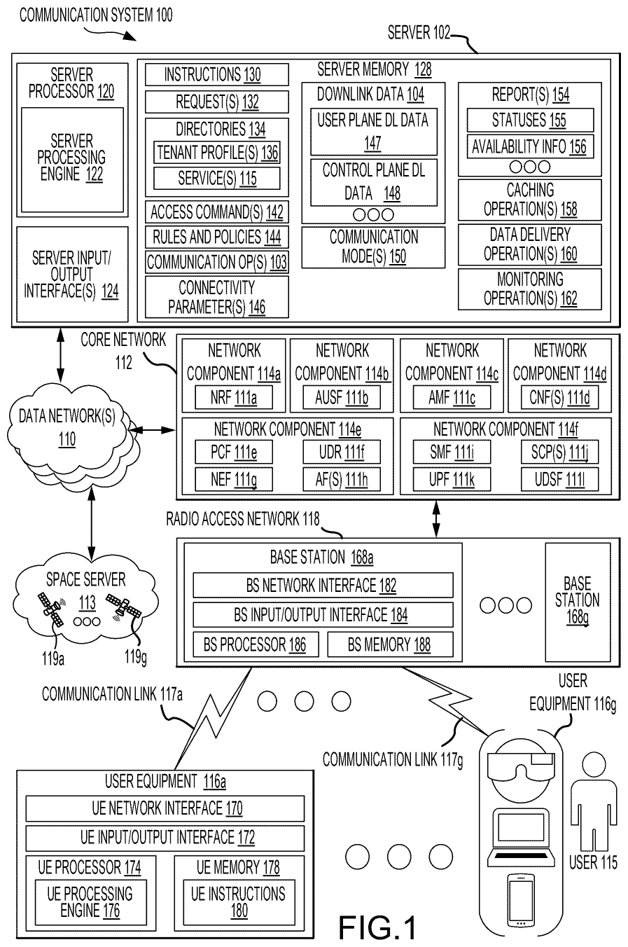

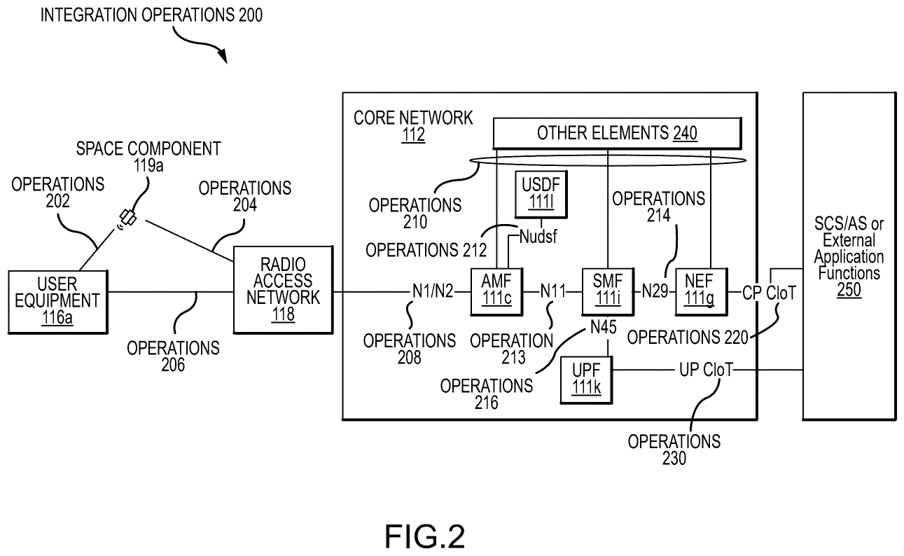

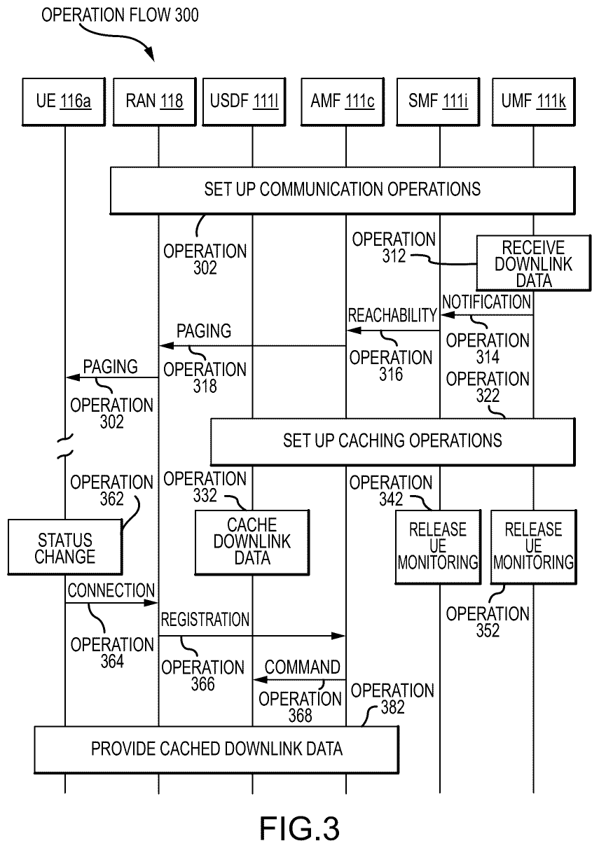

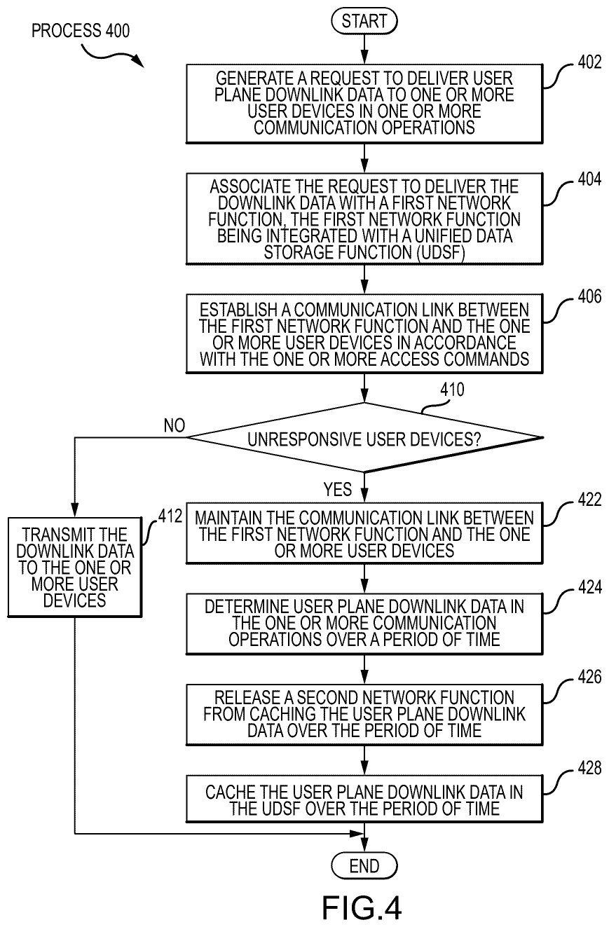

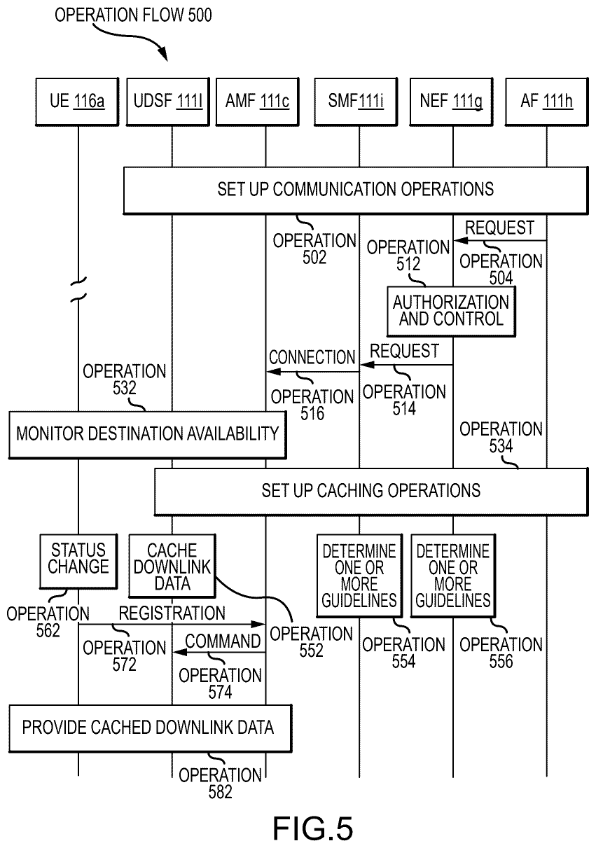

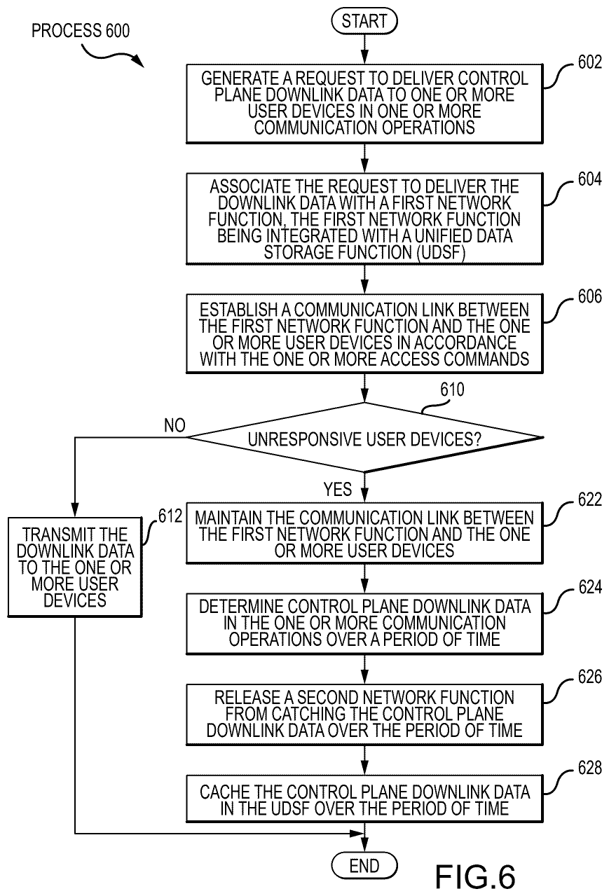

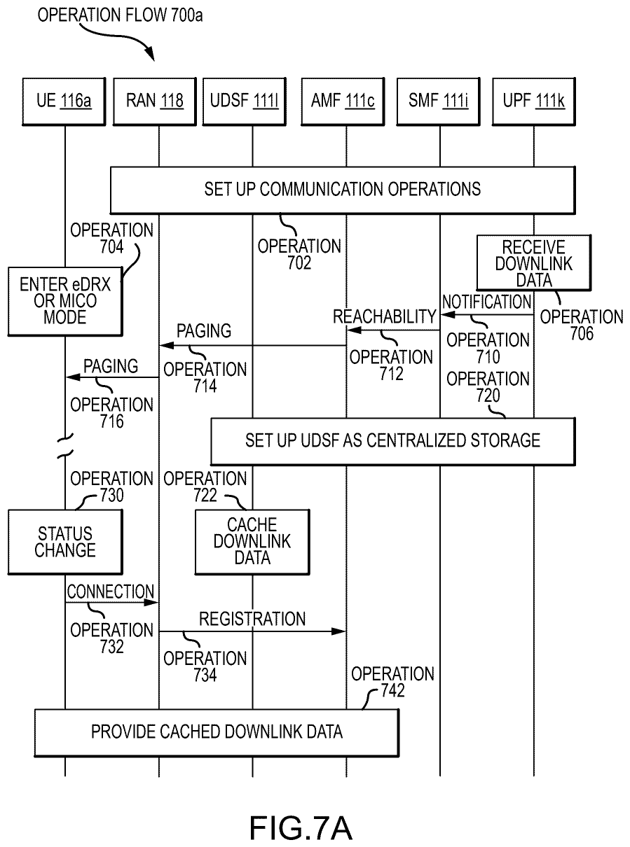

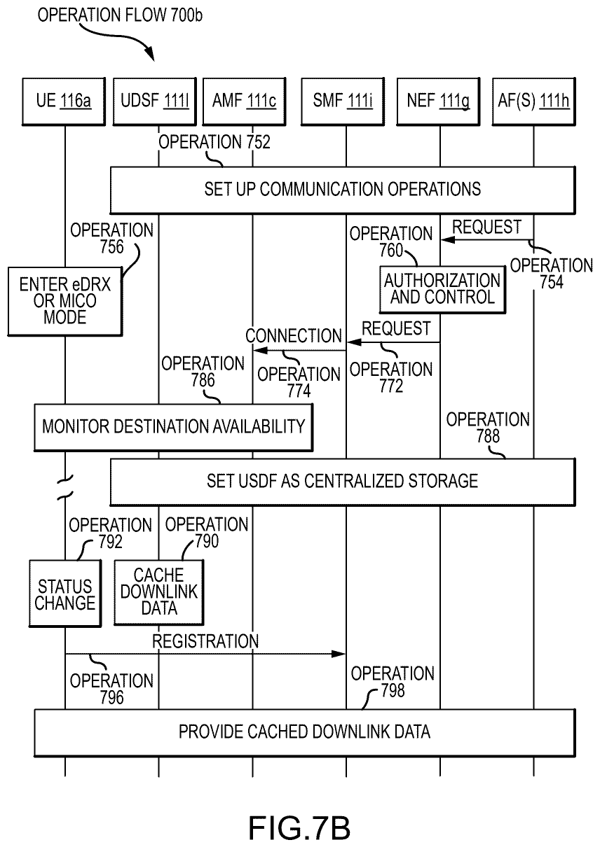

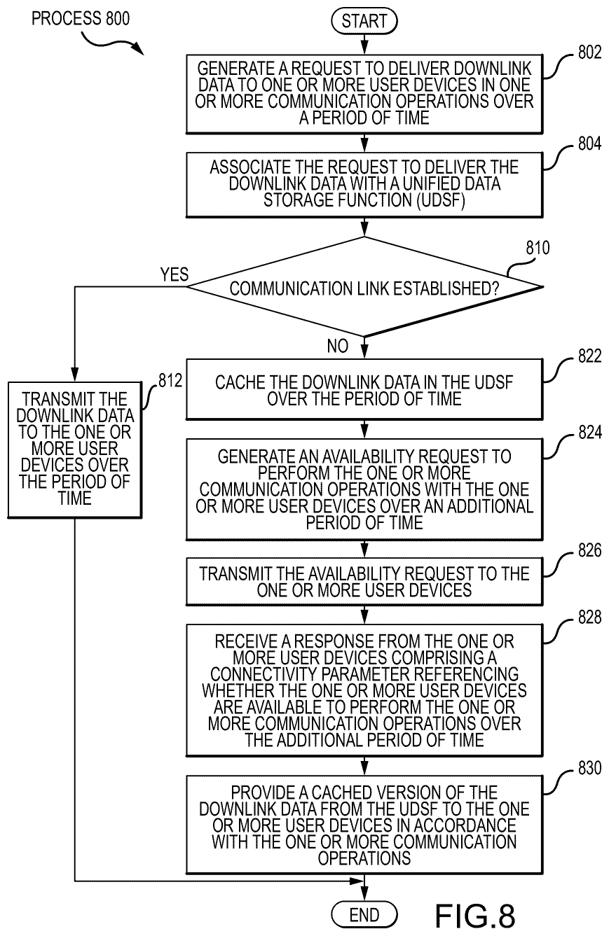

In one or more embodiments, systems and methods described herein are configured to dynamically deliver downlink data for communication operations in cellular internet-of-things (CIoT) and/or Non-Terrestrial Networks (NTN). In one or more embodiments, FIG. 1 illustrates a communication system 100 in which a server 102 is configured to dynamically control one or more communication operations 103 associated with downlink data. FIG. 2 illustrates integration operations 200 performed by the communication system 100 of FIG. 1. FIG. 3 illustrates an operation flow 300 in which the communication system 100 of FIG. 1 is configured to dynamically deliver downlink data 104 for user plane communication operations 103 in cellular internet-of-things (CIoT). FIG. 4 illustrates a process 400 to implement the operation flow 300 of FIG. 3. FIG. 5 illustrates an operation flow 500 in which the communication system 100 of FIG. 1 is configured to dynamically deliver downlink data 104 for control plane communication operations 103 in CIoT. FIG. 6 illustrates a process 600 to implement the operation flow 500 of FIG. 5. FIGS. 7A and 7B illustrate respective operation flows 700a and 700b in which the communication system 100 of FIG. 1 is configured to dynamically implement unified data storage function (UDSF)-based data retrieval for user equipment in extended discontinuous reception (eDRX) and mobile initiated connection only (MICO) modes. FIG. 8 illustrates a process 800 to implement the operation flow 700a of FIG. 7A and the operation flow 700b of FIG. 7B.

### Communication System Overview

FIG. 1 illustrates a diagram of a communication system 100 (e.g., a wireless communication system) that comprises a server 102 configured to improve downlink communication operations 103 in one or more data networks 110, a core network 112, and/or a radio access network (RAN) 118, in accordance with one or more embodiments. In the communication system 100 of FIG. 1, the server 102 may be communicatively coupled to the one or more data networks 110, the core network 112, and the RAN 118. In FIG. 1, the server 102 is communicatively coupled to multiple user equipment 116a-116g (collectively, user equipment 116) via the RAN 118 and multiple corresponding communication links 117a-117g (collectively, communication links 117) shown as being established between each user equipment 116 and the RAN 118. As represented by a user equipment 116g, the user equipment 116 may be operated or attended to by one or more users 115. In the example of FIG. 1, the server 102 may be communicatively coupled to multiple additional devices in the communication system 100. While FIG. 1 shows the server 102 connected directly to the one or more data networks 110, the server 102 may be located inside the core network 112 as part of one or more network components 114 (e.g., any of the network components 114a-114g) in the core network 112.

In one or more embodiments, the communication system 100 comprises a space server 113 comprising multiple space components 119a-119e (collectively, space components 119), the user equipment 116a-116g (collectively, user equipment 116), the RAN 118, the core network 112, the one or more data networks 110, and the server 102. In some embodiments, the communication system 100 may comprise a Fifth Generation (5G) mobile network or wireless communication system, utilizing high frequency bands (e.g., 24 Gigahertz (GHz), 39 GHz, and the like) or lower frequency bands such (e.g., frequency range FR1 Sub 6 GHz - less than 7.125 GHz). In this regard, the communication system 100 may comprise a large number of antennas. In some embodiments, the communication system may perform one or more communication operations 103 associated with 5G New Radio (NR) protocols described in reference to the Third Generation Partnership Project (3GPP). As part of the 5G NR protocols, the communication system 100 may perform one or more millimeter (mm) wave technology operations to improve bandwidth or latency in wireless communications.

In some embodiments, the communication system 100 may be configured to partially or completely enable communications via one or more various radio access technologies (RATs), wireless communication technologies, or telecommunication standards, such as Global System for Mobiles (GSM) (e.g., Second Generation (2G) mobile networks), Universal Mobile Telecommunications System (UMTS) (e.g., Third Generation (3G) mobile networks), Long Term Evolution (LTE) of mobile networks, LTE-Advanced (LTE-A) mobile networks, 5G NR mobile networks, or Sixth Generation (6G) mobile networks.

### Service-Based Architecture

The communication system 100 may comprise a service-based architecture (SBA). The SBA may be an organization scheme in the core network 112 that comprises authentication, security, session management, and aggregation of traffic from end devices (e.g., the user equipment 116). In the SBA, the core network 112 may be representative of the 5G Core network and comprises multiple network components 114. In the SBA, the network components 114 are hardware (e.g., electronic circuitry with communication ports, a processor, and a memory) configured to host and/or perform one or more specific Network Functions (NFs) 111. Herein, network components 114a-114f configured to perform one or more NFs 111 may be referenced using an NF-associated name. For example, a network component 114a configured to perform a Network Repository Function (NRF) 111a may be referred to as an NRF (or an NRF network component). In another example, one of the network components 114a-114f may comprise a version of the server 102 with a server processor 120 configured to perform one or more specific NFs 111.

In some embodiments, individual network components 114 provide services 108 or resources to other network components 114 performing different NFs 111. In other embodiments, each NF may be a service provider that allocates one or more resources in communications inside or outside the network components 114 to provide one or more services 108. The services 108 may be specific for each of the network components 114 and their respective NFs 111 instead of each of the network components 114 providing and consuming processing resources and memory resources to perform multiple NFs 111 in the core network 112. In 5G NR mobile networks, the SBA is defined by the 3GPP standards to comprise one or more network components 114 configured to perform specific NFs 111 to provide control plane operations and user plane operations. In the 5G NR, the control plane comprises any part of the communication system 100 that controls operations and routing associated with data packets and forwarding operations. Further, in the 5G NR, the user plane comprises any part of the communication system 100 that carries user traffic operations.

In one or more embodiments, the SBA may be configured to provide network slices in accordance with specific application scenarios. A network slice may be one or more portions of a collection of NFs 111 that are combined into providing specific application resources and/or network resources. In some embodiments, access to the application resources and/or the network resources may be provided to one or more user equipment 116 simultaneously via web-based Application Programming Interfaces (APIs). The APIs may enable flexible and agile deployment of innovative services 108. An API may be a set of instructions that, when executed by a processor, perform modular or cloud-native functions and procedures allowing creation of applications (e.g., the services 108) that access features or data of an operating system, application, or other service in the communication system 100.

### Communication System Components

### Server

In one or more embodiments, the system and method may be performed by an apparatus, such as a server, communicatively coupled to multiple network components in a core network, one or more base stations in a radio access network, and one or more user equipment. The server 102 is generally any device that is configured to process data, communicate with the data networks 110, one or more network components 114 in the core network 112, the RAN 118, and the user equipment 116. The server 102 may be configured to monitor, track data, control routing of signal, and control operations of certain electronic components in the communication system 100, associated databases, associated systems, and the like, via one or more interfaces. The server 102 is generally configured to oversee operations of the server processing engine 122. The operations of the server processing engine 122 are described further below. In some embodiments, the server 102 comprises the server processor 120, one or more server Input (I)/Output (O) interfaces 124, and a server memory 128 communicatively coupled to one another. The server 102 may be configured as shown, or in any other configuration. As described above, the server 102 may be located in one of the network components 114 located in the core network 112 and may be configured to perform one or more NFs 111 associated with communication operations of the core network 112. The server 102 may be configured to request access to one or more Application Functions (AFs, such as the one or more AF 111h) dedicated to specific functionality provided by a given network slice.

The server 102 may be configured to perform one or more integration operations 200 described in reference to FIG. 2. The server 102 may be configured to perform the operation flow 300 described in reference to FIG. 3. The server 102 may be configured to execute the process 400 described in reference to FIG. 4. The server 102 may be configured to perform the operation flow 500 described in reference to FIG. 5. The server 102 may be configured to execute the process 600 described in reference to FIG. 6. The server 102 may be configured to perform the operation flow 700a described in reference to FIG. 7A and the operation flow 700b described in reference to FIG. 7B. The server 102 may be configured to execute the process 800 described in reference to FIG. 8.

In one or more embodiments, the server processor 120, the server I/O interfaces 124, and the server memory 128 may be located at a same location or distributed over multiple remote locations separate from one another.

The server processor 120 may comprise one or more processors operably coupled to and in signal communication with the server I/O interfaces 124, and the server memory 128. The server processor 120 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 120 may be a programmable logic device, a microcontroller, a microprocessor, or any suitable combination of the preceding. The one or more processors in the server processor 120 are configured to process data and may be implemented in hardware or software executed by hardware. For example, the server processor 120 may be an 8-bit, a 16-bit, a 32-bit, a 64-bit, or any other suitable architecture. The server processor 120 may comprise an arithmetic logic unit (ALU) to perform arithmetic and logic operations, processor registers that supply operands to the ALU, and store the results of ALU operations, and a control unit that fetches software instructions such as server instructions 130 from the server memory 128 and executes the server instructions 130 by directing the coordinated operations of the ALU, registers and other components via the server processing engine 122. The server processor 120 may be configured to execute various instructions. For example, the server processor 120 may be configured to execute the server instructions 130 to perform functions or perform operations disclosed herein, such as some or all of those described with respect to FIGS. 1-8. In some embodiments, the functions described herein are implemented using logic units, FPGAs, ASICs, DSPs, or any other suitable hardware or electronic circuitry.

In the example of FIG. 1, the server I/O interfaces 124 may comprise one or more displays configured to display a two-dimensional (2D) or three-dimensional (3D) representation of a service. Examples of the representations may comprise, but are not limited to, a graphical or simulated representation of an application, diagram, tables, or any other suitable type of data information or representation. In some embodiments, the one or more displays may be configured to present visual information to one or more users 115. The one or more displays may be configured to present visual information to the one or more users 115 updated in real-time. The one or more displays may be a wearable optical display (e.g., glasses or a head-mounted display (HMD)) configured to reflect projected images and enable user to see through the one or more displays. For example, the one or more displays may comprise display units, one or more lenses, one or more semi-transparent mirrors embedded in an eye glass structure, a visor structure, or a helmet structure. Examples of display units comprise, but are not limited to, a cathode ray tube (CRT) display, a liquid crystal display (LCD), a liquid crystal on silicon (LCOS) display, a light emitting diode (LED) display, an organic LED (OLED) display, an active-matrix OLED (AMOLED) display, a projector display, or any other suitable type of display. In another embodiment, the one or more displays are a graphical display on the server 102. For example, the graphical display may be a tablet display or a smartphone display configured to display the data representations.

In one or more embodiments, the server I/O interfaces 124 may be hardware configured to perform one or more communication operations. The server I/O interfaces 124 may comprise one or more antennas as part of a transceiver, a receiver, or a transmitter for communicating using one or more wireless communication protocols or technologies. In some embodiments, the server I/O interfaces 124 may be configured to communicate using, for example, NR or LTE using at least some shared radio components. In other embodiments, the server I/O interfaces 124 may be configured to communicate using single or shared radio frequency (RF) bands. The RF bands may be coupled to a single antenna, or may be coupled to multiple antennas (e.g., for a multiple-input multiple output (MIMO) configuration) to perform wireless communications.

The server I/O interfaces 124 may comprise one or more server network interfaces that may be any suitable hardware or software (e.g., executed by hardware) to facilitate any suitable type of communication in wireless or wired connections. These connections may comprise, but not be limited to, all or a portion of network connections coupled to additional network components 114 in the core network 112, the RAN 118, the user equipment 116, the space components 119 in the space server 113, the Internet, an Intranet, a private network, a public network, a peer-to-peer network, the public switched telephone network, a cellular network, a local area network (LAN), a metropolitan area network (MAN), a wide area network (WAN), and a satellite network. The server network interface 124 may be configured to support any suitable type of communication protocol.

The server I/O interfaces 124 may comprise one or more administrator interfaces that may be user interfaces configured to provide access and control to of the server 102 to one or more users 115 via the user equipment 116 or electronic devices. The one or more users 115 may access the server memory 128 upon confirming one or more access credentials to demonstrate that access or control to the server 102 may be modified. In some embodiments, the one or more administrator interfaces may be configured to provide hardware and software resources to the one or more users 115. Examples of user devices comprise, but are not limited to, a laptop, a computer, a smartphone, a tablet, a smart device, an Internet-of-Things (IoT) device, a simulated reality device, an augmented reality device, or any other suitable type of device. The administrator interfaces may enable access to one or more graphical user interfaces (GUIs) via an image generator display (e.g., the one or more displays), a touchscreen, a touchpad, multiple keys, multiple buttons, a mouse, or any other suitable type of hardware that allow users 115 to view data or to provide inputs into the server 102. The server 102 may be configured to allow users 115 to send requests to one or more network components 114 or network.

The server memory 128 may be volatile or non-volatile and may comprise a read-only memory (ROM), random-access memory (RAM), ternary content-addressable memory (TCAM), dynamic random-access memory (DRAM), and static random-access memory (SRAM). The server memory 128 may be implemented using one or more disks, tape drives, solid-state drives, and/or the like. The server memory 128 is operable to store the server instructions 130, one or more requests 132, one or more directories 134 comprising access to a plurality of tenant profiles 136 associated with the one or more services 108 and the one or more of the NFs 111, one or more access commands 142, one or more rules and policies 144, the one or more communication operations 103, one or more connectivity parameters 146, downlink data 104 comprising user plane downlink data 147 and control plane downlink data 148 among others, one or more communication modes 150 associated with one or more user equipment 116, one or more reports 154 comprising one or more statuses 155 and one or more availability information 156 associated with the user equipment 116, one or more caching operations 158, one or more data delivery operations 160, and one or more one or more monitoring operations 162. In the server memory 128, the server instructions 130 may comprise commands and controls for operating one or more specific NFs 111 in the core network 112 when executed by the server processing engine 122 of the server processor 120.

In one or more embodiments, the access commands 142 are configured to establish one or more communication sessions between two or more network components 114 in the core network 112. The access commands 142 may be configured to establish one or more communication sessions between one or more network components 114 in the core network 112 and one of the user equipment 116. Each of the access commands 142 may establish a communication session between a first network component 114a of the network components 114 comprising the server 102 and a second network component 114b of the network components 114 based at least in part upon a first access command 142a of the access commands 142. The access commands 142 may be routing and configuration information for reinstating or reestablishing communication sessions when a change is detected in the operations of the core network 112. For example, in response to losing a specific communication session established with the first access command 142a, the server 102 may attempt to reinstate the specific communication session based at least in part upon a second access command 142b. The access commands 142 may be dynamically or periodically updated from another of the network components 114 in the core network 112. Herein, communication sessions refer to communication signals exchanged between the server 102 and additional network components 114 in the core network 112. In some embodiments, the access commands 142 are provided to the server 102 from another of the network components 114 performing a specific NF. The access commands 142 may be configured to enable access of the one or more services 108. The access commands 142 may be configured to enable access of one or more name-spaces (not shown) and/or one or more slice groups (not shown) in a given containerized cluster (e.g., clusters in containerized environments, such as Kubernetes environments).

The directories 134 may be configured to store service-specific information, tenant-specific information, and/or user-specific information. The directories 134 may enable the server 102 to confirm tenant credentials to access one or more network components (e.g., one of the network components 114 configured to perform the NRF 111a, an Authentication Server Function (AUSF) 111b, an Access and Management Function (AMF) 111c, one or more Cloud Network Functions (CNFs) 111d, a Policy Control Function (PCF) 111e, a Unified Data Repository (UDR) 111f, a Network Exposure Function (NEF) 111g, one or more AFs 111h, a Session Management Function (SMF) 111i, one or more Service Communication Proxys (SCPs) 111j, a User Plane Function (UPF) 111k, a Unified Data Storage Function (UDSF) 111l, or the like) in the core network 112. The directories 134 may be configured to store the tenant profiles 136 and a reference to the one or more services 108. The directories 134 may be configured to store provider-specific information and service-specific information. The provider-specific information may enable the server 102 to validate credentials associated with a specific provider (e.g., one of the NFs 111) against corresponding user-specific information and service-specific information. The directories 134 may be configured to store service-specific information and/or user-specific information. The directories 134 may enable the server 102 to confirm user credentials to access the one or more network components 114 (e.g., one of the network components 114 configured to host and/or perform one or more NFs 111 in the core network 112). The directories 134 may be configured to store provider-specific information. The directories 134 may enable the server 102 to validate credentials associated with a specific provider (e.g., one of the NFs) against corresponding user-specific information in the directories 134.

The requests 132 may be a communication or a message configured to indicate a request for access of an application (via an API) or a service 108. The requests 132 may be one or more messages and/or signaling received at the server 102. The requests 132 may be generated to request delivers of downlink data 104 to one or more user devices (e.g., network components 114, user equipment 116, and the base stations 168 among others) in one or more communication operations 103. The server 102 may be configured to associate one or more requests to deliver downlink data with one or more NFs 111 hosted in one or more network components 114. The one or more NFs 111 may be configured to perform one or more communication operations 103 at least partially integrated with the UDSF 111l. the downlink data 104 may comprise user plane downlink data 147 and control plane downlink data 148 among others. The requests 132 may be one or more availability requests to perform one or more communication operations 103 with the one or more user devices. The requests 132 may be generated by the server 102. The requests 132 may be availability requests transmitted to the one or more user devices. The requests 132 may be communications and/or messages requesting access to specific network resources in a network slice in accordance with a corresponding priority level. Further, the requests 132 may be messages comprised in one or more communication operations 103. The requests 132 may be configured to request one or more connectivity allowances (e.g., access) between the server 102, the user equipment 116, the base stations 168, one or more space components 119, and one or more of the network components 114. The requests 132 may be generated by and/or transmitted to specific departments or tenants performing communication operations 103 in the communication system 100. The requests 132 may be fulfilled in accordance with one or more entitlements.

The rules and policies 144 may be security configuration commands or regulatory operations predefined by an organization or one or more users 115. In one or more embodiments, the rules and policies 144 may be dynamically defined by the one or more users 115. The one or more rules and policies 144 may be one or more policies as defined in the 3GPP standards. The rules and policies 144 may be security configuration commands or regulatory operations predefined by an organization or one or more users 115. In one or more embodiments, the rules and policies 144 may be dynamically defined by the one or more users 115. The rules and policies 144 may be prioritization rules configured to regulate data signaling or control signaling of the communication session. The one or more rules and policies 144 may be predetermined or dynamically assigned by a corresponding user 115 or an organization associated with the user 115.

The connectivity parameters 146 may be one or more configuration commands configured to indicate changes and/or modifications to one or more communication operations 103. The connectivity parameters 146 may be system level agreements configured to define one or more levels of services 108 expected by a tenant and/or set metrics by which the services 108 are measured, and the remedies or penalties. The connectivity parameters 146 may be configuration information and/or commands to control and/or modify the communication operations 103 and/or operations performed by the NFs 111 in the cores of the core network 112. In one or more embodiments, the connectivity parameters 146 are one or more configuration scripts configured to instruct one or more network components 114 in the core network 112 to implement one or more access commands 142 to establish one or more communication sessions. The connectivity parameters 146 may enable automation of routing and configuration of network components 114 in the core network 112. In this regard, the connectivity parameters 146 may reconfigure multiple cloud-NFs (CNFs) that establish initial communication sessions with at least one NRF in a communication path comprising one or more additional network components 114. In this regard, the connectivity parameters 146 may be generated by the server 102 to instruct routing and configuration of communication procedures in the communication system 100.

The one or more communication operations 103 may be one or more data exchanges performed between two or more network devices in the communication system 100. The network devices may comprise the server 102, the one or more network components 114, the one or more base stations 168, the one or more space components 119, and the one or more user equipment 116 among others. In one or more embodiments, the communication operations 103 may be audio communications exchanged as part of audio conversations (e.g., during a telephonic call) between two or more network devices. The communication operations 103 may be image and/or text communications exchanged as part of image-based conversations (e.g., during videocalls and/or chat exchanges) between two or more network devices. The one or communication operations 103 may be one or more operations executed by the server processor 120 configured to enable data objects to be exchanged between the server 102, the one or more network components 114, the one or more base stations 168, the one or more space components 119, and the one or more user equipment 116. In one or more embodiments, the communication operations 103 may be configured to indicate one or more data objects to be exchanged between the server 102 and at least one of the user devices 106. The server 102 may be configured to generate and analyze one or more communication operations 103. The server 102 may be configured to perform one or more operations to evaluate whether the communication operations 103 belong to a specific user equipment 116.

The downlink data 104 may be information transmitted downstream and/or in the direction of the user equipment 116. The user plane downlink data 147 may be downlink data associated with the User Plane (e.g., also referred to as the Data Plane). The user plane downlink data 147 may be configured to carry user traffic in the communication system 100. The user plane downlink data 147 may be downlink data 104 comprising the Packet Data Convergence Protocol (PDCP), the Radio Link Control (RLC), and the Medium Access Control (MAC) as defined by the 3GPP standards. The user plane downlink data 147 may comprise downlink data 104 associated with the Radio Resource Control layer (RRC) configure to configure lower layers. The user plane downlink data 147 may comprise downlink data 104 associated with transmission of user data. The user plane downlink data 147 may comprise information associated with data forwarding operations, packet routing and switching operations, quality of service (QoS) enforcement operations, encryption and decryption operations, PDCP operations, RLC operations, and MAC operations. The data forwarding operations may comprise transportation of data between the UE and the core network. The packet routing and switching operations may comprise management of paths that data packets take through the network. The QoS enforcement operations may comprise ensuring that user traffic meets target QoS levels. The QoS levels may be predefined and/or dynamically defined in accordance with the rules and policies 144. The encryption and decryption operations may comprise securing user data during communication operations 103 and/or data transmission. The PDCP operations may comprise handling header compression, encryption, and integrity protection during communication operations 103. The RLC operations may comprise management of data segmentation and reassembly, error correction, and flow control. The MAC operations may comprise scheduling data transmissions, handling error correction, and managing resource allocation.

The control plane downlink data 148 may be downlink data associated with the Control Plane. The control plane downlink data 148 may comprise downlink data 104 configured to establish, maintain, and terminate connections between the user equipment 116 and the network. The control plane downlink data 148 may comprise downlink data 104 comprising information associated with management of signaling and control functions and data flow. The control plane downlink data 148 may comprise information associated with authentication and authorization operations, mobility management operations, Radio Resource Control (RRC) operations, QoS management operations, signaling for call setup and release operations, RRC operations, and non-access stratums (NAS) operations. The authentication and authorization operations may comprise ensuring that the user equipment 116 is authorized to access the network. The mobility management operations may comprise management of handovers between cells to maintain connectivity. The RRC operations may comprise allocation of channels and power levels and management of connections and/or communication links 117 between the user equipment 116 and the base stations 168. The QoS management operations may comprise ensuring target quality of service for different data streams. The signaling for call setup and release operations may comprise management of initiation and termination of communication operations 103. The NAS operations may comprise handling of signaling between the user equipment 116 and the core network 112, including Mobility Management Entity (MME) Operations.

The one or more reports 154 may be communications or messages configured to indicate information to one or more of the network components 114, the base stations 168, the space components 119, and/or the user equipment 116. The reports 154 may comprise one or more updates associated with capabilities and/or configuration of the user equipment 116. The reports 154 may be signaling comprising statuses 155 and/or availability information 156 associated with the one or more of the network components 114, the base stations 168, the space components 119, and/or the user equipment 116. For example, the statuses 155 may be received in response to one or more availability requests 132. The statuses 155 may be one or more acknowledgement signals comprising current capabilities at the user equipment 116. In some embodiments, the statuses 155 may be configured to reference whether one or more network devices (e.g., user devices, such as the user equipment 116) are outside a paging window. In other embodiments, the statuses 155 may be configured to reference whether one or more network devices are inside a paging window. The paging windows may be a period of time in which communication links 117 are determined to be available. The availability information 156 may be information indicating whether the one or more of the network components 114, the base stations 168, the space components 119, and/or the user equipment 116 are available to perform one or more communication operations 103.

There may be one or more connection management (CM) and/or registration management (RM) states and/or modes associated with one or more network devices in one or more of the NFs (e.g., the AMF 111c). The CM may comprise one or more operations configured to establish and release a NAS signaling connection between user equipment 116 and the AMF 111c over a 3GPP interface. The NAS signaling connection may be used to enable NAS signaling exchange between the user equipment 116 and the core network 112. The NAS signaling connection may comprise both Access Network (AN) signaling connections between the user equipment 116 and a specific AN and an N2 interface connection for the user equipment 116 between the specific AN and the AMF 111c. The user equipment 116 in a CM_idle state may not comprise NAS signaling connections established with the AMF 111c over an N1 interface. The user equipment 116 may be configured to perform cell selection and/or cell reselection according to technical specification 38.304 of the 3GPP standard and PLMN selection according to technical specification 23.122 of the 3GPP standard. The user equipment 116 in a CM_connected state may not comprise NAS signaling connections established with the AMF 111c over the N1 interface. The NAS signaling connection may use an RRC connection between the user equipment 116 and a Next Generation (NG)-RAN and an NG application protocol (AP) association in the user equipment 116 between the specific AN and the AMF 111c. The user equipment 116 may be in CM_connected state with an NGAP association in the user equipment 116 that is not bound to any transport network layer association (TNLA) between the specific AN and the AMF 111c. After completing the NAS signaling procedure, the AMF 111c may be configured to release the NAS signaling connection with the user equipment 116. The CM may comprise one or more operations configured to register or deregister user equipment 116/users 115 with a communication network and establish user context in the communication network. The CM may be used to establish and release the signaling connection between the user equipment 116 and the AMF 111c. In an RM_deregistered state, the user equipment 116 may not be registered with the communication network. The AMF 111c may not comprise context associated with the user equipment 116 with valid location or routing information for the user equipment 116. Herein, the user equipment 116 may not be reachable by the AMF 111c. In an RM_registered state, the user equipment 116 may be registered with the communication network. In the RM_registered state, the user equipment 116 may be configured to receive services that require registration with the communication network.

The CM states may be used to reflect one or more NAS signaling connections of the user equipment 116 with the AMF 111c: In a CM_idle state (e.g., CM-IDLE or CM idle), the user equipment 116 may be determined to comprise no NAS signaling connection established with the AMF 111c. The user equipment 116 may be configured to perform cell selection/cell reselection according to technical specification 38.304 of the 3GPP standards. The user equipment 116 may be configured to perform public land mobile network (PLMN) selection according to technical specification 23.122 of the 3GPP standards. In an RM_registered state (e.g., RM-REGISTERED or RM registered), information required for initiating communication with the user equipment 116 may be stored. Herein, the AMF 111c may be able to retrieve stored information required for initiating communication with the user equipment 116. In events where the user equipment 116 are in a CM_idle state and an RM_registered state, the AMF 111c may be configured to perform a network triggered service request procedure when the AMF 111c is configured to exchange signaling or mobile terminated (MT) data to be sent to the user equipment 116. The AMF 111c may be configured to send a paging request to the user equipment 116 in the manner defined in the technical specification 23.502 of the 3GPP standards. In some embodiments, the AMF 111c may be configured to enter a CM_connected state (e.g., CM-CONNECTED or CM connected) for the user equipment 116 whenever a specific connection is established for the user equipment 116 between an access point and the AMF 111c.

In one or more embodiments, communications exchanged with the user equipment 116 via an N2 interface may be configured to initiate a transition of the user equipment 116 in the AMF 111c from a CM_idle state to a CM_connected state. The user equipment 116 may be in a MICO mode while on the CM_idle state. In some embodiments, the user equipment 116 may be in a CM_connected state after completion of a NAS signaling procedure and/or a decision of the AMF 111c to release one or more NAS signaling connections with the user equipment 116. In the CM_connected state, the user equipment 116 may be configured to enter a CM_idle state whenever a specific signaling connection is released. For example, the user equipment 116 may be configured to enter an RRC Idle state. For user equipment 116 in a CM_connected state, the AMF 111c may be configured to enter a CM_idle state for the user equipment 116 whenever a signaling connection and a user plane connection for the user equipment 116 are released (e.g., inhibited from performing) upon completion of one or more of the release procedures specified in technical specification 23.502 pf the 3GPP standards. Further, the AMF 11c may be configured to keep a current CM state associated with the user equipment 116.

The AMF 111c may be in a CM_connected state until the user equipment 116 de-registers from the core network 112. The user equipment 116 may be in a CM_connected state in an RRC Inactive state as defined in technical specification 38.300 of the 3GPP standards. In some embodiments, when the user equipment 116 are in the RRC Inactive state, the user equipment 116 may be configured to manage reachability by the RAN 118, with assistance information from the core network 112 and paging of the user equipment 116 by the RAN 118.

In one or more embodiments, when the user equipment 116 are in an RM_registered state and/or a CM_connected state, the server 102 may be configured to determine that a CM context is established in the user equipment 116 and the user equipment 116 are tracked via one or more communication links 117. When the user equipment 116 are in the RM_registered state and/or the CM_idle state, locations for the user equipment 166 are known to the AMF 111c with an accuracy of a list of tracking areas containing a certain number of tracking areas. In some embodiments, the idle modes may be configured to enable the user equipment 116 to periodically become available for downlink broadcast paging without connection with a specific gNB. The idle mode may be configured to allow the user equipment 116 to save power resources because the user equipment 116 scans downlink at discrete intervals.

In one or more embodiments, the one or more caching operations 158 may be one or more communication operations 103 configured to cache data at one or more NFs in accordance with one or more communication sessions. The one or more data delivery operations 160 may be one or more communication operations 103 configured to delivery data from the core network 112 and/or specific NFs in the core network 112 to one or more network devices. The one or more monitoring operations 162 may be one or more communication operations 103 configured to monitor data in interfaces communicatively coupled to one or more network devices. The one or more caching operations 158, the one or more data delivery operations 160, and the one or more monitoring operations 162 may be one or more operations described in reference to FIGS. 2-8.

The one or more communication modes 150 may be one or more communication states for one or more network devices as defined by the 3GPP standards. As non-limiting examples, the communication modes 150 may be connectivity modes, configuration modes, and/or performance modes. The communication modes 150 may be disconnected modes, connected modes, and/or idle modes.

In one or more embodiments, an extended/enhances Discontinuous Reception (eDRX) mode is one of the communication modes 150 configured as a stand-by mode (e.g., sleeping modes) associated with the user equipment 116. The user equipment 116 may not receive data during a period of time and/or as long as the eDRX mode is active. The eDRX mode may be a mechanism configured to extend a cycle (e.g., a sleeping duration and/or power saving state) between an idle mode DRX and a connected mode DRX. The user equipment 116 may be in the eDRX mode with or without power save mode (PSM) to further reduce consumption of power resources. The Power Save Mode (PSM) may be a feature of user equipment 116 comprising cellular capabilities that turns off the user equipment 116 and puts the user equipment 116 to sleep without reconnecting to the specific communication network at a subsequent wake up time. The server 102 may be configured to reconnect the user equipment to a network (e.g., the core network 1112) when required.

In one or more embodiments, a Mobile Initiated Connection Only (MICO) mode is one or the communication modes 150 of operation for wireless communication devices. The user equipment 116 may be configured to receive Mobile Terminated (MT) data when the user equipment 116 transitions to a connected state. This transition to the connected state while the user equipment 116 are in a MICO mode may be triggered by the user equipment 116. The user equipment 116 may not be paged in MICO mode.

In one or more embodiments, the user equipment 116 may be comprise CIoT network capabilities and or NTN capabilities that enable access to the eDRX and the MICO modes and/or states. In some embodiments, the UDSF 111l may be configured to perform one or more interface-based service operations in the communication system 100. The interfaces may be one or more reference points and/or physical interfaces configured to communicatively couple one or more network components 114 hosting and/or performing one or more NFs 111. The interfaces may be SBIs configured to transfer and/or deliver data and/or commands between the network components 114. The service operations may comprise query, creation, deletion, and update of one or more NFs, allowing any NFs to make use of the UDSF 111l to store and retrieve unstructured data. In the context of non-IP data delivery (NIDD) service delivery, the server 102 may be configured to enable a service gateway to send machine terminated (e.g., Mobile Terminal (MT) and/or Mobile Terminated (MT)) data reliably to user equipment 116 that are in stand-by and/or idle modes. As described above, these communication modes 150 may be sleep and/or off the grid modes and/or states. The service gateway may be configured to preemptively sends NIDD messages towards the user equipment 116. If the user equipment 116 is determined to be unreachable at a specific moment in time, the data may be buffered into the UDSF 111l using one or more create service operations as defined in the 3GPP standards (e.g., technical specification 29.504). In some embodiments, create service operations may be used by an NF service consumer (e.g., NEF 111g) to create data into the UDR.

In one or more embodiments, CIoT capabilities and the NTN capabilities may be features associated with one or more user equipment 116. The CIoT capabilities may be configured to enable user equipment 116 with IoT capabilities to access cellular networks. The NTN capabilities may be configured to enable user equipment 116 with satellite capabilities to communicate with the space server 113 and/or one or more space components 119.

### User Equipment

In one or more embodiments, each of the user equipment 116 may be any computing device configured to communicate with other devices, such as the server 102, other network components 114 in the core network 112, databases, and the like in the communication system 100. Each of the user equipment 116 may be configured to perform specific functions described herein and interact with one or more network components 114 in the core network 112 via one or more base stations 168a-168g (collectively, base stations 168). Examples of user equipment 116 comprise, but are not limited to, a laptop, a computer, a smartphone, a tablet, a smart device, an IoT device, a simulated reality device, an augmented reality device, or any other suitable type of device.

In one or more embodiments, referring to the user equipment 116a as a non-limiting example of the user equipment 116, the user equipment 116a may comprise a user equipment (UE) network interface 170, a UE I/O interface 172, a UE processor 174 executing operations via a UE processing engine 176, and a UE memory 178 comprising one or more instructions 180 configured to be executed by the UE processor 174. The UE network interface 170 may be any suitable hardware or software (e.g., executed by hardware) to facilitate any suitable type of communication in wireless or wired connections. These connections may comprise, but not be limited to, all or a portion of network connections coupled to additional network components 114 in the core network 112, the RAN 118, the one or more space components 119 in the space server 113, the Internet, an Intranet, a private network, a public network, a peer-to-peer network, the public switched telephone network, a cellular network, a local area network (LAN), a metropolitan area network (MAN), a wide area network (WAN), and a satellite network. The UE network interface 170 may be configured to support any suitable type of communication protocol.

The UE I/O interface 172 may be hardware configured to perform one or more communication operations. The UE I/O interface 172 may comprise one or more antennas as part of a transceiver, a receiver, or a transmitter for communicating using one or more wireless communication protocols or technologies. In some embodiments, the UE I/O interface 172 may be configured to communicate using, for example, 6G, 5G NR or LTE using at least some shared radio components. In other embodiments, the UE I/O interface 172 may be configured to communicate using single or shared RF bands. The RF bands may be coupled to a single antenna, or may be coupled to multiple antennas (e.g., for a MIMO configuration) to perform wireless communications. In some embodiments, the user equipment 116a may comprise capabilities for voice communication, mobile broadband services (e.g., video streaming, navigation, and the like), or other types of applications. In this regard, the UE I/O interface 172 of the user equipment 116a may communicate using machine-to-machine (M2M) communication, such as machine-type communication (MTC), or another type of M2M communication.

In some embodiments, the user equipment 116a is communicatively coupled to one or more of the base stations 168 via the one or more communication links 117a-117g (e.g., collectively, the communication links 117). The user equipment 116a may be a device with cellular communication capability such as a mobile phone, a hand-held device, a computer, a laptop, a tablet, a smart watch or other wearable device, or virtually any type of wireless device. In some applications, the user equipment 116 may be referred to as a UE, UE device, or terminal.

The UE processor 174 may comprise one or more processors operably coupled to and in signal communication with the UE network interface 170, the UE I/O interface 172, and the UE memory 178. The UE processor 174 is any electronic circuitry, including, but not limited to, state machines, one or more CPU chips, logic units, cores (e.g., a multi-core processor), FPGAs, ASICs, or DSPs. The UE processor 174 may be a programmable logic device, a microcontroller, a microprocessor, or any suitable combination of the preceding. The one or more processors in the UE processor 174 are configured to process data and may be implemented in hardware or software executed by hardware. For example, the UE processor 174 may be an 8-bit, a 16-bit, a 32-bit, a 64-bit, or any other suitable architecture. The UE processor 174 comprises an ALU to perform arithmetic and logic operations, processor registers that supply operands to the ALU, and store the results of ALU operations, and a control unit that fetches software instructions such as UE instructions 180 from the UE memory 178 and executes the UE instructions 180 by directing the coordinated operations of the ALU, registers, and other components via a UE processing engine 176. The UE processor 174 may be configured to execute various instructions. For example, the UE processor 174 may be configured to execute the UE instructions 180 to implement functions or perform operations disclosed herein, such as some or all of those described with respect to FIGS. 1-8. In some embodiments, the functions described herein are implemented using logic units, FPGAs, ASICs, DSPs, or any other suitable hardware or electronic circuitry.

### Radio Access Network

In one or more embodiments, the RAN 118 enables the user equipment 116 to access one or more services 108 in the core network 112 and/or the space server 113. The one or more services 108 may be a mobile telephone service, a Short Message Service (SMS) message service, a Multimedia Message Service (MMS) message service, an Internet access, cloud computing, or other types of data services. The RAN 118 may comprise the base stations 168 in signal communication with the user equipment 116 via the one or more communication links 117. Each of the base stations 168 may service the user equipment 116a-116g. In some embodiments, while multiple base stations 168 are shown connected to multiple user equipment 116 via the communication links 117, one or more additional base stations 168 may be connected to one or more additional user equipment 116 via one or more additional communication links 117. For example, the base stations 168a-168g may exchange connectivity signals with the user equipment 116a via the communication link 190a. In another example, the base station 168g may exchange connectivity signals with the user equipment 116g via the communication link 190g. In yet another example, the base stations 168 may service some user equipment 116 located within a geographic area serviced by one of the base stations 168.

In one or more embodiments, referring to the base station 168a as a non-limiting example of the base stations 168, the base station 168a may comprise a base station (BS) network interface 182, a BS I/O interface 184, a BS processor 186, and a BS memory 188. The BS network interface 182 may be any suitable hardware or software (e.g., executed by hardware) to facilitate any suitable type of communication in wireless or wired connections between the core network 112 and the user equipment 116. These connections may comprise, but not be limited to, all or a portion of network connections coupled to additional network components 114 in the core network 112, other base stations 168, the user equipment 116, the Internet, an Intranet, a private network, a public network, a peer-to-peer network, the public switched telephone network, a cellular network, a LAN, a MAN, a WAN, and a satellite network. The BS network interface 182 may be configured to support any suitable type of communication protocol.

The BS I/O interface 184 may be hardware configured to perform one or more communication operations. The BS I/O interface 184 may comprise one or more antennas as part of a transceiver, a receiver, or a transmitter for communicating using one or more wireless communication protocols or technologies. In some embodiments, the BS I/O interface 184 may be configured to communicate using, for example, 6G, 5G NR, or LTE using at least some shared radio components. In other embodiments, the BS I/O interface 184 may be configured to communicate using single or shared RF bands. The RF bands may be coupled to a single antenna, or may be coupled to multiple antennas (e.g., for a MIMO configuration) to perform wireless communications. In some embodiments, the base station 168a may allocate resources in accordance with one or more routing and configuration operations obtained from the core network 112. In some embodiments, resources may be allocated to enable capabilities in the user equipment 116 for voice communication, mobile broadband services (e.g., video streaming, navigation, and the like), or other types of applications.

In some embodiments, the base station 168a is communicatively coupled to one or more of the user equipment 116 via the one or more communication links 117. In some applications, the base stations 168 may be referred to as a BS, evolved Node B (eNodeB or eNB), a next generation Node B, gNodeB, gNB, or terminal.

The BS processor 186 may comprise one or more processors operably coupled to and in signal communication with the BS network interface 182, the BS I/O interface 184, and the BS memory 188. The BS processor 186 is any electronic circuitry, including, but not limited to, state machines, one or more CPU chips, logic units, cores (e.g., a multi-core processor), FPGAs, ASICs, or DSPs. The BS processor 186 may be a programmable logic device, a microcontroller, a microprocessor, or any suitable combination of the preceding. The one or more processors in the BS processor 186 are configured to process data and may be implemented in hardware or software executed by hardware. For example, the BS processor 186 may be an 8-bit, a 16-bit, a 32-bit, a 64-bit, or any other suitable architecture. The BS processor 186 comprises an ALU to perform arithmetic and logic operations, processor registers that supply operands to the ALU, and store the results of ALU operations, and a control unit that fetches software instructions (not shown) from the BS memory 188 and executes the software instructions by directing the coordinated operations of the ALU, registers, and other components via a processing engine (not shown) in the BS processor 186. The BS processor 186 may be configured to execute various instructions. For example, the BS processor 186 may be configured to execute the software instructions to implement functions or perform operations disclosed herein, such as some or all of those described with respect to FIGS. 1-8. In some embodiments, the functions described herein are implemented using logic units, FPGAs, ASICs, DSPs, or any other suitable hardware or electronic circuitry.

### Core Network

The core network 112 may be a network configured to manage communication sessions for the user equipment 116. In one or more embodiments, the core network 112 may establish connections between user equipment 116 and a particular data network 110 in accordance with one or more communication protocols. The core network 112 may be a multi-core network 112 configured to comprise multiple cores. In this regard, the multi-core network may comprise multiple NFs 111 in each core. In the example of FIG. 1, the core network 112 comprises the network component 114a configured to host and/or perform the NRF 111a, the network component 114b configured to host and/or perform the AUSF 111b, the network component 114c configured to host and/or perform the AMF 111c, the network component 114d configured to host and/or perform the CNFs 111d, the network component 114e configured to perform the PCF 111e, the UDR 111f, the NEF 111g, and AF 111h, and the network component 114f configured to perform the SMF 111i, the one or more SCPs 111j, the UPF 111k, and the UDSF 111l. Herein, as a non-limiting example, while the NRF 111a is associated with the network component 114a, the core network 112 may comprise multiple network component 114 hosting and/or performing the NRF 111a. For example, a Unified Data Management (UDM) may be part of a core.

In some embodiments, the NRF 111a may comprise a service registration procedure that accesses the one or more databases to store or retrieve routing and configuration information associated with one or more network components 114 in the core network 112. The NRF 111a may access the database to discover services 108 offered by other networks or other network components 114 with service discovery procedures and service authorization procedures. The NRF 111a may maintain a list of available NFs operations available in the core network 112 and any network components 114 associated with performing a given NF 111. The NRF 111a may also performs registration and discovery of service such that different NFs 111 may find each other via APIs. As an example, when the SMF 111i is registered to the NRF 111a, the SMF 111i is discoverable by the AMF 111c when the user equipment 116 attempts to access a given service type via the SMF 111i. In other embodiments, the NFs 111 may be connected via a communication bus to all other additional network elements in the core network 112. In the SBA, the NRF 111a may enable access between the user equipment 116 and the services 108 offered via the NFs 111.

In one or more embodiments, the network components 114d hosting and/or performing the one or more CNFs 111d may be configured to operate multiple operations associated with one or more services 108, while dynamically directing network traffic within the core network 112. The network components 114f hosting and/or performing the SMF 111i may be configured to manage one or more communication sessions established between network components 114 of the core network 112, allocate and manage resource allocation routing for the user equipment 116, user plane selection, QoS and configuration enforcements for the control plane, service registration, discovery, establishment, and the like. In other embodiments, the network component 114c hosting and/or performing the AMF 111c may be configured to manage mobility, registration, connections, and overall access for the other network components 114 in the core network 112. The AMF 111c may act as an entry point for connections between the user equipment 116 and a given service. In yet other embodiments, the network component 114f hosting and/or performing the one or more SCPs 111j may be configured to provide a point of entry for a cluster of NFs 111 in the core network 112 to the user equipment 116 once the user equipment 116 are discovered by the NRF 111a. This allows the SCPs 111j to be delegated discovery points in the core network 112. The network component 114b hosting and/or performing the AUSF 111b may be configured to share performing of some of the aforementioned operations with a Unified Data Management (UDM) (not shown). In this regard, the AUSF 111b may be configured to perform authentication processes while the UDM manages user data for any other processes in the core network 112. In other embodiments, the UDM may receive requests for subscriber data from the SMF 111i, the AMF 111c, and the AUSF 111b before providing any services 108. The AUSF 111b may be implemented in one of the network components 114 configured to enable the AMF 111c to authenticate the user equipment 116. The network component 114e hosting and/or performing the PCF 111e may be configured to provide a policy control framework in which the rules and policies 144 are implemented in accordance with one or more application guidelines. In some embodiments, the PCF 111e may apply policy decisions to services 108 provided, accessing subscription information, and the like to control behavior associated with the core network 112. The network component 114e hosting and/or performing the UDR 111f configured to operate as a centralized data repository for subscription data, subscriber policy data, session information, context information, and application states. In some embodiments, the UDR 111f may be configured to provide API integrations with other NFs 111 to retrieve subscriber subscription and policy data. The UDR 111f may notify other NFs 111 of changes in subscriber data, supports real-time or batch (e.g., bulk) data access provisioning and subscriber data provisioning, and manages service parameters and application data for advanced applications.

In one or more embodiments, one or more network components 114 hosting and/or performing one or more Network Data Analytics Functions (NWDAFs) may be configured to streamline processes that regulate how core network data is produced and consumed, as well as to generate insights and take actions to enhance end-user experience. Further, one or more network components hosting and/or performing one or more Network Slice Admission Control Functions (NSACFs) may be configured to monitor and control the number of registered user equipment 116 and established Protocol Data Unit (PDU) sessions per network slice and feed the information to one or more AFs for analysis and further processing.

In some embodiments, the network component 114e hosting and/or performing the NEF 111g may be configured to securely expose network capabilities and events provided by 3GPP NFs 111 to the AFs 111h. The NEF 111g may be configured to enable the AFs 111h to securely provide information to 3GPP networks and may authenticate, authorize, and/or assist in throttling the AFs 111h. The NEF 111g may be configured to translate information received from the AFs 111h to data sent to internal 3GPP NFs 111, and vice versa. The NEF 111g may be configured to expose information (e.g., collected from other 3GPP NFs 111) to the AFs 111h. The NEF 111g may be configured to support one or more Power Flow Detection (PFD) functions that may allow the AFs 111h to provision the one or more PFDs and store and retrieve PFDs in the UDR. The NEF 111g may be further configured to provision the one or more PFDs to the SMF 111i. A specific NEF 111g instance may support one or more of the functionalities described above and consequently an individual NEF 111g may support a subset of one or more APIs specified for capability exposure. For example, as described in technical specification 29.522 of the 3GPP standards, the NEF 111g may be configured to access the UDR located in a same PLMN as the NEF 111g.

The network component 114e hosting and/or performing the AF 111h may be configured to access the core network 112 via the NEF 111g in order to access network capabilities. As described in technical specification 29.517 of the 3GPP standards, the AF 111h is a functional element configured to provide service-related information and/or application-related information to NF service consumers (e.g., user equipment 116). The AF 111h may be configured to allow NF service consumers to subscribe to and/or unsubscribe from periodic notifications and/or notifications related to detection of subscribed events. The AF 111h may be configured to provide an application function exposure service configured to allow NF service consumers to subscribe to, modify, and/or unsubscribe from application events. Further, the service may be configured to notify NF service consumers with corresponding subscriptions about observed events on the AF 111h.

The network component 114f hosting and/or performing the UPF 111k may be configured to provide an interconnect point between a mobile infrastructure and the data networks 110 (e.g., encapsulation and decapsulation of protocols for the user plane). As described in technical specification 23.501 of the 3GPP standards, the PDU session anchor point may be configured to provide mobility within and/or between one or more Radio Access Technologies (RATs). The UPF 111k may be configured to send one or more end marker packets to the base stations 168. The UPF 111k may be configured to perform packet routing and forwarding, including performing a role of an Uplink Classifier (UL-CL) directing flows to specific data networks 110 based on traffic-matching filters and a branching point.

The network component 114f hosting and/or performing the UDSF 111l may be configured to store and retrieve unstructured data (e.g., data that is not defined in 3GPP specifications). Herein, structured data may refer to data for which structure is defined in 3GPP specifications. The UDSF 111l may be configured to run timers and get notified on timer expiry. As described in technical specification 23.501 of the 3GPP standards, the UDSF 111l is deployed in the same network where the CP NF is located and the same UDSF 111l may be shared by all the NFs 111 in the PLMN to store and/or retrieve respective data. An NF 111 may have a corresponding UDSF 111l depending on operator configuration.

In some embodiments, the core network 112 enables the user equipment 116 to communicate with the server 102, or another type of device, located in a particular data network 110 or in signal communication with a particular data network 110. The core network 112 may implement a communication method that does not require the establishment of a specific communication protocol connection between the user equipment 116 and one or more of the data networks 110. The core network 112 may include one or more types of network devices (not shown), which may perform different NFs 111.

In some embodiments, the core network 112 may include a 6G, 5G NR, and/or an LTE access network (e.g., an evolved packet core (EPC) network) among others. In this regard, the core network 112 may comprise one or more logical networks implemented via wireless connections or wired connections. Each logical network may comprise an end-to-end virtual network with dedicated power, storage, or computation resources. Each logical network may be configured to perform a specific application comprising individual policies, rules, or priorities. Further, each logical network may be associated with a particular Quality of Service (QoS) class, type of service, or particular user associated with one or more of the user equipment 116. For example, a logical network may be a Mobile Private Network (MPN) configured for a particular organization. In this example, when the user equipment 116a is configured and activated by a wireless network associated with the RAN 118, the user equipment 116a may be configured to connect to one or more particular network slices (i.e., logical networks) in the core network 112. Any logical networks or slices that may be configured for the user equipment 116a may be configured using one of the network components 114 of FIG. 1 performing the NSSF that may store a subscription profile associated with the user equipment 116a, in a network component operating as a Unified Data Management (UDM). Further, when the user equipment 116a may request a connection to a particular logical network or slice, the user equipment 116a may send a request to the network component performing the AMF 111c. The AMF 111c may provide a list of allowed logical networks or slices to the user equipment 116a. The user equipment 116a may then request a PDU connection with one or more of the provided logical networks or slices.

In one or more embodiments, the server 102 is configured to perform multiple network slicing operations. In this regard, the network slicing operations may be configured to run multiple logical networks as virtually independent organization operations on a common physical infrastructure. The organization operations may comprise service instance layer operations, network slice instance layer operations, and resources layer operations.

### Data Networks

In the example system 100 of FIG. 1, the data networks 110 may facilitate communication within the communication system 100. This disclosure contemplates that the data networks 110 may be any suitable network operable to facilitate communication between the server 102, the space server 113, the core network 112, the RAN 118, and the user equipment 116. The data networks 110 may comprise one or more transport networks that include any interconnecting system capable of transmitting audio, video, signals, data, messages, or any combination of the preceding. The data networks 110 may include all or a portion of a LAN, a WAN, an overlay network, a software-defined network (SDN), a virtual private network (VPN), a packet data network (e.g., the Internet), a mobile telephone network (e.g., cellular networks, such as 4G, 5G, or 6G), a Plain Old Telephone (POT) network, a wireless data network (e.g., WiFi, WiGig, WiMax, and the like), a Long Term Evolution (LTE) network, a Universal Mobile Telecommunications System (UMTS) network, a peer-to-peer (P2P) network, a Bluetooth network, a Near Field Communication network, a Zigbee network, or any other suitable network, operable to facilitate communication between the components of the communication system 100. In other embodiments, the communication system 100 may not have all of these components or may comprise other elements instead of, or in addition to, those above.

### Space Server

In the example system 100 of FIG. 1, the space server 113 comprises one or more of the space components 119. In some embodiments, the space components 119 (e.g., the space component 119a and the space component 119g representative of the space components 119a-119g) are communicatively coupled to one or more of the base stations 168. The space components 119 may be configured to perform some or all of the operations described in relation to one or more of the network components 114 or one or more of the base stations 168. For example, the space component 119a may comprise a space component processor performing one or more of the operations described in reference to the network components 114. The space server 113 may comprise one or more of the space components 119 shown in FIG. 1.

In one or more embodiments, the space server 113 is configured to modify one or more operations of the data networks 110. The operations may comprise changes and/or modifications to a transport process in the data networks 110. The transport process may comprise one or more operations described in reference to TS 38.211 and/or TS 38.212 of the 3GPP standards. In some embodiments, the space server 113 may be configured to regulate and/or modify a transport layer shared between the space server 113, the server 102, the data networks 110, the core network 112, the RAN 118, and/or the user equipment 116. In some embodiments, the space server 113 is located in at least one space component 119 orbiting the Earth. The space components 119 may be configured to operate in low orbits, medium orbits, and/or geostationary orbits. In one or more embodiments, the space server 113 is configured to perform one or more of the operations described in reference to the server 102. For example, the space server 113 may be configured to allocate one or more radio resources (e.g., one or more network resources in the communication system 100). The space server 113 and the server 102 may be configured to control and/or modify spectrum channels and transport channels in the communication system 100. The transport channels may be intermediate channel between logical channels and physical channels. The spectrum channel may be configured to allocate communication transmissions at different bandwidths in a spectrum.

The space components 119 may configured to operate in low orbits as a low Earth orbit (LEO) satellite with an orbit around Earth with a period of 128 minutes or less (e.g., making at least 11.25 orbits per day) and an eccentricity (e.g., deviation of a curve or orbit from circularity) less than 0.25. The space components 119 may configured to operate in medium orbits as a medium Earth orbit (MEO) satellite with an Earth-centered orbit with an altitude above a low Earth orbit (LEO) and below a high Earth orbit (HEO). The orbit may be between 2,000 Kilometers and 35,786 Kilometers (e.g., about 1,243 miles and 22,236 miles) above sea level. The space components 119 operating as the MEO may comprise an orbital period of equal or greater than 2 hours and less than 24 hours. The space components 119 may configured to operate in geostationary orbits as a geostationary (GEO) satellite is an Earth-orbit placed at an altitude of approximately 22,300 miles or 35,800 kilometers directly above the equator. In this regard, the space components 119 may be configured to revolve in a same direction the Earth rotates (e.g., west to east).

In one or more embodiments, one or more of the space components 119 may appear nearly stationary in the sky to a ground-based observer. These space components 119 may complete one orbit in about 24 hours, which is the same amount of time it takes for the Earth to rotate once on its axis and/or moving in synchronization with the Earth's rotation. The space components 119 may be configured to receive, amplify, and retransmit radio signals to and from the Earth.

### Integrated Operations

FIG. 2 illustrates an example of integrated operations 200 implemented by the communication system 100 of FIG. 1, in accordance with one or more embodiments. While the integrated operations 200 comprise multiple operations 202-230 are shown to be performed by the user equipment 116a, the space component 119a, the RAN 118, and one or more NFs 111 in the core network 112, additional electronic devices or components in the server 102 (e.g., the server processor 120 in the server 102) or in the user equipment 116a (e.g., the UE processor 174) may be configured to perform one or more of the operations 202-230. In the example of FIG. 2, the operations 202-230 may be one or more of the communication operations 103 comprising one or more of the caching operations 158, one or more of the data delivery operations 160, and/or one or more of the monitoring operations 162. The server 102 may be configured to integrate the UDSF 111l into one or more communication operations 103 performed by one or more NFs 111.

In the example of FIG. 2, the space component 119a and the user equipment 116a may be configured to exchange one or more operations 202, the space component 119a and the RAN 118 may be configured to exchange one or more operations 204, the user equipment 116a and the RAN 118 may be configured to exchange one or more operations 206, the RAN 118 and the AMF 111c may be configured to exchange one or more operations 208, the AMF 111c, the SMF 111i, the NEF 111g, and other elements 240 of the core network 112 may be configured to exchange one or more operations 210, the AMF 111c and the UDSF 111l may be configured to exchange one or more operations 212, the AMF 111c and the SMF 111i may be configured to exchange one or more operations 213, the SMF 111i and the NEF 111g may be configured to exchange one or more operations 214, the SMF 111i and the UPF 111k may be configured to exchange one or more operations 216, the NEF 111g and the SCS/AS or external application functions 250 may be configured to exchange one or more operations 220, and the UPF 111k and the SCS/AS or external application functions 250 may be configured to exchange one or more operations 230.

The operations 202-230 may be signaling, commands, and data exchanged via one or more reference points and/or interfaces. The reference points and/or interfaces may be one or more reference points as defined in the 3GPP standards. In some embodiments, the AMF 111c may communicate with the RAN 118 via an N1 reference point and/or an N2 reference point, the AMF 111c may communicate with the UDSF 111l via an Nudsf reference point, the AMF 111c may communicate with the SMF 111i via an N11 reference point, the SMF 111i may communicate with the NEF 111g via an N29 reference point, the SMF 111i may communicate with the UPF 111k via an N45 reference point, the NEF 111g may be configured to communicate with a services capability server/application server (SCS/AS) or external application functions 250 via an CP CIoT reference point, the UPF 111k may be configured to communicate with the SCS/AS or external application functions 250 via an UP CIoT reference point. The AMF 111c, the SMF 111i, the NEF 111g, and the UPF 111k may be configured to communicate with the other elements 240 of the core network 112 via one or more reference points. One or more of the SCS/AS or external application functions 250 may be hosted and/or performed by the server 102.

In one or more embodiments, the server 102 is configured to monitor, trigger, and/or implement one or more communication operations 103 in the NFs 111. The server 102 may be configured to enhance CIoT and NTN capabilities of user equipment 116. Specifically, the server 102 may be configured to efficiently manage and delivery downlink data delivery to the user equipment 116 operating in power-saving modes, such as eDRX and MICO modes. In CIoT and NTN capabilities, the user equipment 116 may be configures to operate in power-saving modes. These modes significantly reduce power consumption by allowing the user equipment 116 to stay in a sleep and/or idle state for extended periods of time.

In some embodiments, the user equipment 116 may not respond to network paging attempts during asleep and/or idle states. Herein, certain NFs may be inhibited and/or prevented from caching data, maintaining session states, and monitoring statuses 155 for the user equipment 116, while the UDSF 111l takes over the caching operations 158. The server 102 may be configured to manage and deliver downlink data 104 in wireless communication networks. The server 102 may be configured to integrate the UDSF 111l with the control plane and the data plane using standard 3GPP SBIs. Herein, the server 102 is configured to enable dynamic and efficient management of downlink data 104 caching and just-in-time delivery, reduce network signaling, improve scalability, and enhance a reliability of downlink communication in power-saving modes. The reference points of interaction between two NFs 111 and/or electronic devices may be performed one or more operations defined in the 3GPP standards.

In the integration operations 200, the UDSF 111l may be configured to store various types of data required by the NFs 111, such as mobile downlink data 104 and session state data. In some embodiments, instead of specific NFs 111 (e.g., the NEF 111g in CP CIoT or the SMF 111i and/or the UPF 111k in UP CIoT) performing MT data caching and listening for user equipment 116 reachability notification, the NFs 111 (e.g., the NEF 111g in CP CIoT or the SMF 111i in UP CIoT) may be configured to send the received MT data directly to the AMF 111c, inhibit (relief and/or release) current multiple NFs 111 from maintaining multiple session states, data caching, timing the delivery, and performing complex signaling procedure. If the user equipment 116 are in a CM_connected state, the AMF 111c may be configured to directly forward the MT data to the user equipment 116. Otherwise, the AMF 111c may be configured to determine whether paging is allowed for the user equipment 116. If allowed (e.g., the user equipment 116 is not in MICO mode and/or the user equipment 116 is in eDRX paging time window (PTW)), the user equipment 116 may be paged and the MT data may be delivered to the user equipment 116. At this stage, the AMF 111c may be configured to confirm back to the SMF 111i and/or the NEF 111g on successful MT data delivery. If the user equipment 116 are not reachable and/or paging is not allowed (e.g., the user equipment 116 are in MICO mode and/or the user equipment are not in eDRX PTW), the AMF 111c is configured to cache the MT data to the UDSF 111l.

In one or more embodiments, when the user equipment 116 wakes up and connects to the core network 112 in a CM_connected state, the AMF 111c may be configured to retrieve cached MT data from the UDSF 111l and forward the cached MT data to the user equipment 116. At this stage, the AMF 111c may be configured to confirm back to the SMF 111i and/or the NEF 111g on successful MT data delivery. If the user equipment 116 are in eDRX mode in a PTW window and the user equipment 116 are not yet connected to the network, the AMF 111c may be configured to page the user equipment 116 and deliver the cached MT data retrieved from the UDSF 111l. The AMF 111c may be configured to confirm back to the SMF 111i and/or the NEF 111g on successful MT data delivery.

In some embodiments, the integration operations 200 may be implemented to reduce a need for per-network function-based data caching and maintain multiple session states and waiting on reachability statuses 155 from the user equipment 116. The user equipment 116 may be effectively used during a reachability window, avoiding racing condition on reachability operations as the NFs 111 are not required to race to reinstate sessions with the user equipment 116. In some embodiments, the integration operations 200 may be configured to reduce signaling flow complexity and simplify NF design while supporting massive IoT deployments by minimizing network resource usage and signaling overhead. The integration operations may provide a reliable downlink delivery by ensuring data is not lost and may be delivered as soon as the user equipment 116 become available. Further, the integration operations 200 may be configured to enhance a reliability and robustness of downlink communication operations 103 delivering downlink data 104 to user equipment 116 in power-saving modes. In some embodiments, the integration operations 200 may be configured to free up memory resources, processing resources, and power resources within one or more NFs 111 by allowing certain NFs 111 to handle more connections and data flows. In particular, the integration operations 200 may reduce a frequency of reachability camping, session state maintaining, and associated signaling with user equipment 116 while optimizing network performance.

In one or more embodiments, the integration operations 200 may be implemented and/or performed as one or more processes (e.g., the process 400 described in FIG. 4, the process 600 described in FIG. 6, and the process 800 described in FIG. 8) for managing and delivering downlink data in a CIoT or NTN operations. The integration operations 200 may integrate the UDSF 111l with the control plane and the data plane of the communication system 100. The processes may be configured to utilize standard 3GPP SBIs for communication between certain NFs 111 and the UDSF 111l. As described above, the integration operations 200 may be configured to cache downlink data 104 in the UDSF 111l when the user equipment 116 are not reachable or paging is not allowed, retrieve and deliver cached data from the UDSF 111l to the user equipment 116 when user equipment 116 become reachable or wake up.

In some embodiments, the integration operations 200 may inhibit the NEF 111g from monitoring reachability subscription for user equipment 116 and relief (e.g., release) the NEF 111g from caching the downlink data 104 and timing the delivery of downlink data 104. Further, the SMF 111i may avoid monitoring reachability subscription for user equipment 116 and relief the SMF 111i from caching the downlink data 104 and timing the delivery of the downlink data 104. In other embodiments, the integration operations 200 may inhibit the UPF 111k from caching the downlink data 104 and timing delivery of the downlink data 104. The UDSF 111l may be configured to provide centralized storage for the downlink data 104. The AMF 111c may be configured to provide direct just-in-time delivery for the downlink data 104 without signaling overhead of reachability notification for the user equipment to the NEF 111g and/or the SMF 111i.

In one or more embodiments, the integration operations 200 may be configured to reduce network signaling and improving scalability for massive IoT deployments by minimizing a need for data caching and session state monitoring from certain NFs, improving delivery timing of downlink data 104, and reducing usage of network resources from multiple NFs 111. In some embodiments, the integration operations 200 may be configured to prevent racing conditions to confirm reachability of the user equipment 116 by ensuring timely delivery of downlink data 104 from the AMF 111c to the user equipment 116, thereby avoiding situations where the user equipment 116 become unreachable due to latency between notifications generated by the AMF 111c of reachability requests and the reception of the downlink data 104.

In one or more embodiments, while multiple user equipment 116 are used in certain examples, one or more user equipment may be configured in accordance with the features described in FIGS. 1-8. For example, one or more user equipment 116 may be configured to benefit from the integration operations 200 described in reference to FIG. 2. Further, while downlink data 104 may be used to describe advantages and/or improvements in FIGS. 1-8, the downlink data 104 may refer to user plane downlink data 147, control plane downlink data 148, and/or MT data among others.

### Operation Flow to Dynamically Delivery Downlink Data for User Plane (UP) Cellular Internet-of-Things (IoT)

FIG. 3 illustrates an example operation flow 300 implemented by the communication system 100 of FIG. 1, in accordance with one or more embodiments. The operational flow 300 may comprise one or more of the integration operations 200 described in reference to FIG. 2. While the operation flow 300 comprises multiple operations 302-382 are shown to be performed by the server 102, one or more of the network components 114, the one or more base stations 168 in the RAN 118, the one or more space components 119 in the space server 113, and one or more of the user equipment 116, additional electronic devices or components in the server 102 (e.g., the server processor 120 in the server 102) or in the user equipment 116 (e.g., the UE processor 174 in the user equipment 116a) may be configured to perform one or more of the operations 302-382.

In one or more embodiments, the server 102 is configured to manage and deliver downlink user plane (UP) downlink data 147 in wireless communication networks. The operational flow 300 comprises one or more of the integration operations 200 described in reference to FIG. 2. The operational flow 300 comprises integrating the UDSF 111l with the user plane using standard 3GPP service-based interfaces. In some embodiments, the UDSF 111l may be configured to inhibit and/or prevent certain NFs 111 (e.g., the SMF 111i and/or UPF 111k in UP CIoT) from maintaining individual communications/sessions with user equipment 116 before leaving the core network 112. Instead of multiple NFs 111 performing MT data caching and listening to reachability notifications of user equipment 116, the integration enables the NFs 111 to send received MT data directly to the AMF 111c, relieves the NFs 111 from maintaining multiple session states while a user equipment 116 are unresponsive, data caching, timing the delivery, and performing complex signaling procedures.

In FIG. 3, the operation flow 300 shows the user equipment 116a, the RAN 118, one or more network components 114 hosting and/or performing the UDSF 111l, one or more network components 114 hosting and/or performing the AMF 111c, one or more network components 114 hosting and/or performing the SMF 111i, and one or more network components 114 hosting and/or performing the UPF 111k communicatively coupled to one another. In the example of FIG. 3, the operations 302-382 the user equipment 116a, the RAN 118, the one or more network components 114 hosting and/or performing the UDSF 111l, the one or more network components 114 hosting and/or performing the AMF 111c, the one or more network components 114 hosting and/or performing the SMF 111i, and/or the one or more network components 114 hosting and/or performing the UPF 111k.

At operation 302, the RAN 118, the UDSF 111l, the AMF 111c, the SMF 111i, and the UPF 111k may be configured to set up one or more communication operations 103. Herein, the multiple NFs 111 may be set up and/or initiated in accordance with guidance provided in the 3GPP standards. At operation 312, the UPF 111k may be configured to receive downlink data 104 from the SCS/AS or external application function 250. At this stage, the UPF 111k may be configured to generate a notification indicating that downlink data 104 is available for the user equipment 116a. At operation 314, the UPF 111k is configured to transmit the notification to the SMF 111i (via the N45 reference point). At operation 316, the SMF 111i is configured to transmit a reachability request 132 to the AMF 111c (via the N11 reference point). At operation 318, the AMF 111c is configured to transmit one or more paging signals for the user equipment 116a to the RAN 118 (via the N1 or the N2 reference points). At operation 320, the RAN 118 may be configured to transmit the one or more paging signals to the user equipment 116a. At operation 322, the AMF 111c, the SMF 111i, the UPF 111k, and the UDSF 111l are configured to set up caching operations 158.

The operation flow 300 may continue at operations 332-368. At operation 332, the UDSF 111l is configured to cache the downlink data 104 over a period of time. At operation 342, the SMF 111i is configured to release any monitoring operations 162 for the user equipment 116a. At operation 352, the UPF 111k is configured to release any monitoring operations 162 for the user equipment 116a. At operation 362, the user equipment 116a undergoes a status change from a first status 155a to a second status 155b. At operation 364, the user equipment 116a may transmit a connection signal to the RAN 118 indicating that the user equipment 116 changed from the first status 155a to the second status 155b.

The operation flow 300 may conclude at operation 382, where the RAN 118, the UDSF 111l, and the AMF 111c are configured to provide the cached downlink data 104 to the user equipment 116a.

### Example Process to Dynamically Delivery Downlink Data for User Plane (UP) Cellular Internet-of-Things (CIoT)

FIG. 4 illustrate respective example flowchart of the process 400, in accordance with one or more embodiments. Modifications, additions, or omissions may be made to the process 400. The process 400 may include more, fewer, or other operations than those shown above. For example, operations may be performed in parallel or in any suitable order. While at times discussed as the server 102, one or more of the network components 114, the one or more of the base stations 168, the one or more space components 119, components of any of thereof, or any suitable system or components of the communication system 100 may perform one or more operations of the process 400. For example, one or more operations of the process 400 may be implemented, at least in part, in the form of server instructions 130 of FIG. 1, stored on non-transitory, tangible, machine-readable media (e.g., server memory 128 of FIG. 1 operating as a non-transitory computer-readable medium) that when run by one or more processors (e.g., the server processor 120 of FIG. 1) may cause the one or more processors to perform operations described in operations 402-428.

The process 400 starts at operation 402, where the server 102 may be configured to generate (e.g., communicate) a request 132 to deliver user plane downlink data 147 to one or more user devices (e.g., user equipment 116) in one or more communication operations 103. At operation 404, the server 102 may be configured to associate the request 132 to deliver the downlink data 104 with a first network function (one of the NFs 111). The first network function may be integrated with a UDSF 111l. At operation 406, the server 102 may be configured to establish a communication link 117a between the first network function and the one or more user devices in accordance with one or more access commands 142. The one or more access commands 142 may comprise guidelines to establish one or more communication links 117.

The process 400 continues at operation 410, where the server 102 may be configured to determine whether the one or more user devices are unresponsive. In this regard, the server 102 may determine whether one or more specific user equipment 116 (e.g., one or more user devices) are unresponsive after establishing the communication link 117a between the one or more first network components hosting the first network function and the one or more user devices to receive the user plane downlink data over a period of time. If the server 102 determines that the one or more specific user equipment 116 (e.g., one or more user devices) are responsive (i.e., NO), the process 400 proceeds to operation 412. If the server 102 determines that the one or more specific user equipment 116 (e.g., one or more user devices) are unresponsive (i.e., YES), the process 400 proceeds to operation 422.

The process 400 may conclude at operation 412, where the server 102 is configured to transmit the downlink data 104 to the one or more user devices.

The process 400 may conclude at operations 422-428. In this case, the server 102 may be configured to at least partially perform one or more of the communication operations 103. At operation 422, the server 102 is configured to maintain the communication link 117a between the first network function and the one or more user devices. At operation 424, the server 102 is configured to determine user plane downlink data 147 in the one or more communication operations 103 over a period of time. At operation 426, the server 102 is configured to release a second network function from caching the user plane downlink data 147 over the period of time. Herein, the server 102 may be configured to inhibit one or more second network components hosting a second network function from caching the user plane downlink data 147 over the period of time. At operation 428, the server 102 is configured to cache the user plane downlink data 147 in the UDSF 111l over the period of time.

In some embodiments, the first network function may be the AMF 111c and the second network function may be SMF 111i. Further, the first network function may be AMF 111c and the second network function may be a UPF 111k. The communication link 117a may be established using system interfaces (e.g., SBIs and/or reference points) communicatively coupling one or more third network components hosting and/or performing the UPF 111k and one or more fourth network components hosting and/or performing the SMF 111i, the one or more fourth network components hosting the SMF 111i and one or more fifth network components hosting the AMF 111c, and the one or more fifth network components hosting the AMF 111c and the one or more user devices. In some embodiments, the process 400 comprises caching downlink data 104 in the UDSF 111l when the user equipment 116 are not available and/or caching the downlink data 104 in the UDSF 111l when paging is not allowed with the user equipment 116. The process 400 comprises relieving the SMF 111i to avoid monitoring user equipment reachability subscription, caching the MT data, and timing the MT data delivery. The UPF 111k may be relieved from caching the MT data and timing MT data delivery. The process 400 may cover that the AMF 111c provides direct just-in-time delivery for MT downlink data without signaling overhead of UE reachability notification to the SMF 111i.

### Operation Flow to Dynamically Delivery Downlink Data for Control Plane (UP) Cellular Internet-Of-Things (IoT)

FIG. 5 illustrates an example operation flow 500 implemented by the communication system 100 of FIG. 1, in accordance with one or more embodiments. The operational flow 500 may comprise one or more of the integration operations 200 described in reference to FIG. 2. While the operation flow 500 comprises multiple operations 502-582 are shown to be performed by the server 102, one or more of the network components 114, the one or more base stations 168 in the RAN 118, the one or more space components 119 in the space server 113, and one or more of the user equipment 116, additional electronic devices or components in the server 102 (e.g., the server processor 120 in the server 102) or in the user equipment 116 (e.g., the UE processor 174 in the user equipment 116a) may be configured to perform one or more of the operations 502-582.

In one or more embodiments, the server 102 is configured to manage and deliver downlink control plane (CP) data 148 in wireless communication networks. The operational flow 500 comprises one or more integration operations 200 described in reference to FIG. 4. The operational flow 500 comprises integrating the UDSF 111l with the control plane using standard 3GPP service-based interfaces. Here, the UDSF 111l may be configured to inhibit and/or prevent certain NFs 111 (e.g., the NEF 111g in CP CIoT) from maintaining individual communications/sessions with user equipment 116 before leaving the core network 112. Instead of multiple NFs 111 performing MT data caching and listening to reachability notifications of user equipment 116, the integration enables the NFs 111 to send MT data directly to the AMF 111c, relieves the NFs 111 from maintaining multiple session states while a user equipment 116 are unresponsive, data caching, timing the delivery, and performing complex signaling procedures.

In FIG. 5, the operation flow 500 shows the user equipment 116a, one or more network components 114 hosting and/or performing the UDSF 111l, one or more network components 114 hosting and/or performing the AMF 111c, one or more network components 114 hosting and/or performing the SMF 111i, one or more network components 114 hosting and/or performing the NEF 111g, and one or more network components 114 hosting and/or performing the AF 111h communicatively coupled to one another. In the example of FIG. 5, the operations 502-582 the user equipment 116a, the one or more network components 114 hosting and/or performing the UDSF 111l, the one or more network components 114 hosting and/or performing the AMF 111c, the one or more network components 114 hosting and/or performing the SMF 111i, the one or more network components 114 hosting and/or performing the NEF 111g, and the one or more network components 114 hosting and/or performing the AF 111h.

At operation 502, the UDSF 111l, the AMF 111c, the SMF 111i, the NEF 111g, and the AF 111h may be configured to set up one or more communication operations 103. Herein, the multiple NFs 111 may be set up and/or initiated in accordance with guidance provided in the 3GPP standards. At operation 504, the AF 111h may be configured to a request for providing downlink data 104 from the SCS/AS or external application function 250 to the NEF 111g for the user equipment 116a. At operation 512, the NEF 111g may be configured to perform one or more authorization and control operations. At operation 514, the NEF 111g is configured to transmit a reachability request 132 to the SMF 111i (via the N29 reference point). At operation 516, the SMF 111i is configured to transmit one or more connection signals for the user equipment 116a to the AMF 111c (via the N22 reference point). At operation 532, the AMF 111c and the UDSF 111l are configured to monitor destination availability at the user equipment 116a. At operation 534, the AF 111h, the NEF 111g, the SMF 111i, the AMF 111c, and the UDSF 111l are configured to set up caching operations 158.

The operation flow 500 may continue at operations 552-572. At operation 552, the UDSF 111l is configured to cache the downlink data 104 over a period of time. At operation 554, the SMF 111i is configured to release any monitoring operations 162 for the user equipment 116a. At operation 556, the UPF 111k is configured to release any monitoring operations 162 for the user equipment 116a. At operation 562, the user equipment 116a undergoes a status change from a first status 155a to a second status 155b. At operation 572, the user equipment 116a may transmit a registration signal to the AMF 111c indicating that the user equipment 116 changed from the first status 155a to the second status 155b.

The operation flow 500 may conclude at operation 582, where the UDSF 111l and the AMF 111c are configured to provide the cached downlink data 104 to the user equipment 116a.

### Example Process to Dynamically Delivery Downlink Data for Control Plane (CP) Cellular Internet-of-Things (CIoT)

FIG. 6 illustrate respective example flowchart of the process 600, in accordance with one or more embodiments. Modifications, additions, or omissions may be made to the process 600. The process 600 may include more, fewer, or other operations than those shown above. For example, operations may be performed in parallel or in any suitable order. While at times discussed as the server 102, one or more of the network components 114, the one or more of the base stations 168, the one or more space components 119, components of any of thereof, or any suitable system or components of the communication system 100 may perform one or more operations of the process 600. For example, one or more operations of the process 600 may be implemented, at least in part, in the form of server instructions 130 of FIG. 1, stored on non-transitory, tangible, machine-readable media (e.g., server memory 128 of FIG. 1 operating as a non-transitory computer-readable medium) that when run by one or more processors (e.g., the server processor 120 of FIG. 1) may cause the one or more processors to perform operations described in operations 602-628.

The process 600 starts at operation 602, where the server 102 may be configured to generate (e.g., communicate) a request 132 to deliver control plane downlink data 148 to one or more user devices (e.g., user equipment 116) in one or more communication operations 103. At operation 604, the server 102 may be configured to associate the request 132 to deliver the downlink data 104 with a first network function. The first network function may be integrated with the UDSF 111l. At operation 606, the server 102 may be configured to establish a communication link 117a between the first network function and the one or more user devices in accordance with the one or more access commands.

The process 600 continues at operation 610, where the server 102 may determine whether the one or more user devices are unresponsive. In this regard, the server 102 may determine whether one or more specific user equipment 116 (e.g., one or more user devices) are unresponsive after establishing the communication link 117a between the first network function and the one or more user devices over a period of time. If the server 102 determines that the one or more specific user equipment 116 (e.g., one or more user devices) are responsive (i.e., NO), the process 600 proceeds to operation 612. If the server 102 determines that the one or more specific user equipment 116 (e.g., one or more user devices) are unresponsive (i.e., YES), the process 600 proceeds to operation 622.

The process 600 may conclude at operation 612, where the server 102 is configured to transmit the downlink data 104 to the one or more user devices.

The process 600 may conclude at operations 622-628. In this case, the server 102 may be configured to at least partially perform one or more of the communication operations 103. At operation 622, the server 102 is configured to maintain the communication link 117a between the first network function and the one or more user devices. At operation 624, the server 102 is configured to determine control plane downlink data 148 in the one or more communication operations 103 over a period of time. At operation 626, the server 102 is configured to release a second network function from caching the control plane downlink data 148 over the period of time. Herein, the server 102 may be configured to inhibit one or more second network components hosting a second network function from caching the control plane downlink data 148 over the period of time. At operation 628, the server 102 is configured to cache the control plane downlink data 148 in the UDSF 11l over the period of time.

In some embodiments, the first network function may be the AMF 111c and the second network function may be the NEF 111g. The communication link 117a may be established using system interfaces (e.g., SBIs and/or reference points) communicatively coupling one or more third network components hosting the NEF 111g and one or more fourth network components hosting the SMF 111i, the one or more fourth network components hosting the SMF 111i and one or more fifth network components hosting the AMF 111c, and the one or more fifth network components hosting the AMF 111c and the one or more user devices. The process 600 may comprise caching downlink data 104 in the UDSF 111l when the user equipment 116 are not available and/or caching the downlink data 104 in the UDSF 111l when paging is not allowed with the UE. The process 400 comprises relieving the NEF 111g from monitoring user equipment reachability subscription and caching the MT data and timing the MT data delivery. The process 400 may cover that the AMF 111c provides direct just-in-time delivery for MT downlink data without signaling overhead of user equipment reachability notification to the NEF 111g.

### Operation Flow to Dynamically Implement Unified Data Storage Function (UDSF)-Based Data Retrieval for User Equipment in Extended Discontinuous Reception (eDRX) and Mobile Initiated Connection Only (MICO) Modes

FIGS. 7A and 7B illustrate respective operation flows 700a and 700b implemented by the communication system 100 of FIG. 1, in accordance with one or more embodiments. The operational flows 700a and 700b may comprise one or more of the integration operations 200 described in reference to FIG. 2. While the operation flow 700a comprises multiple operations 702-742 are shown to be performed by the server 102, one or more of the network components 114, the one or more base stations 168 in the RAN 118, the one or more space components 119 in the space server 113, and one or more of the user equipment 116, additional electronic devices or components in the server 102 (e.g., the server processor 120 in the server 102) or in the user equipment 116 (e.g., the UE processor 174 in the user equipment 116a) may be configured to perform one or more of the operations 702-742. While the operation flow 700b comprises multiple operations 752-798 are shown to be performed by the server 102, one or more of the network components 114, the one or more base stations 168 in the RAN 118, the one or more space components 119 in the space server 113, and one or more of the user equipment 116, additional electronic devices or components in the server 102 (e.g., the server processor 120 in the server 102) or in the user equipment 116 (e.g., the UE processor 174 in the user equipment 116a) may be configured to perform one or more of the operations 752-798.

In one or more embodiments, the server 102 is configured to integrate the UDSF 111l with the user plane and the control plane. The server 102 may be configured to use the UDSF 111l as a centralized storage entity within a service-based architecture (SBA). The UDSF 111l may be configured to store various types of data required by the NFs 111, such as mobile downlink data 104 and session state data while UEs are unavailable. In some embodiments, if a user equipment 116 are in a CM_connected state, the AMF 111c may be configured to directly forward the MT data to the user equipment 116. Otherwise, the AMF 111c may be configured to determine whether paging is allowed for the user equipment 116. In this regard, if allowed (e.g., the user equipment 116 are not in MICO mode, and the user equipment are in eDRX paging time window (PTW)), the user equipment 116 may be paged, and the MT data is delivered. At this stage, the AMF 111c may be configured to confirm back to the SMF 111i and/or the NEF 111g on successful MT data delivery. Further, if the user equipment 116 are not reachable and paging is not allowed (e.g., the UE is in MICO mode, or the UE is not in eDRX PTW), the AMF 111c may be configured to cache MT data to the UDSF 111l. In other embodiments, when the user equipment 116 wake up and connect to the core network 112 in the CM_connected state, the AMF 111c may be configured to retrieve prior cached MT data and forward the cached MT data to the user equipment 116. Further, if the user equipment 116 in the eDRX mode are in the PTW and the user equipment 116 are not yet connected to the core network 112, the AMF 11c may be configured to page the user equipment 116 and delivers the cached MT data retrieved from the UDSF 111l.

In FIG. 7A, the operation flow 700a shows the user equipment 116a, the RAN 118, one or more network components 114 hosting and/or performing the UDSF 111l, one or more network components 114 hosting and/or performing the AMF 111c, one or more network components 114 hosting and/or performing the SMF 111i, and one or more network components 114 hosting and/or performing the UPF 111k communicatively coupled to one another. In the example of FIG. 7A, the operations 702-742 may be performed by the user equipment 116a, the RAN 118, the one or more network components 114 hosting and/or performing the UDSF 111l, the one or more network components 114 hosting and/or performing the AMF 111c, the one or more network components 114 hosting and/or performing the SMF 111i, and/or the one or more network components 114 hosting and/or performing the UPF 111k.

At operation 702, the RAN 118, the UDSF 111l, the AMF 111c, the SMF 111i, and the UPF 111k may be configured to set up one or more communication operations 103. Herein, the multiple NFs 111 may be set up and/or initiated in accordance with guidance provided in the 3GPP standards. At operation 704, the user equipment 116a may be configured to enter an eDRX or MICO mode. At operation 706, the UPF 111k may be configured to receive downlink data 104 from the SCS/AS or external application function 250. At this stage, the UPF 111k may be configured to generate a notification indicating that downlink data 104 is available for the user equipment 116a. At operation 710, the UPF 111k is configured to transmit the notification to the SMF 111i (via the N45 reference point). At operation 712, the SMF 111i is configured to transmit a reachability request 132 to the AMF 111c (via the N11 reference point). At operation 714, the AMF 111c is configured to transmit one or more paging signals for the user equipment 116a to the RAN 118 (via the N1 or the N2 reference points). At operation 716, the RAN 118 may be configured to transmit the one or more paging signals to the user equipment 116a.

The operation flow 700a may continue at operations 730-736. At operation 720, the AMF 111c is configured to set the UDSF 111l as a centralized storage. At operation 722, the UDSF 111l may be configured to cache downlink data 104 for a predefined period of time and/or until the user equipment 116 changes from a first status 155a to a second status 155b. At operation 730, the user equipment 116a undergoes a status change from the first status 155a to the second status 155b. At operation 732, the user equipment 116a may transmit a registration signal to the RAN 118 indicating that the user equipment 116 changed from the first status 155a to the second status 155b. At operation 734, the RAN 118 may forward the registration signal to the AMF 111c indicating that the user equipment 116 changed from the first status 155a to the second status 155b.

The operation flow 700a may conclude at operation 742, where the RAN 118, the UDSF 111l, and the AMF 111c are configured to provide the cached downlink data 104 to the user equipment 116a.

In FIG. 7B, the operation flow 700b shows the user equipment 116a, one or more network components 114 hosting and/or performing the UDSF 111l, one or more network components 114 hosting and/or performing the AMF 111c, one or more network components 114 hosting and/or performing the SMF 111i, one or more network components 114 hosting and/or performing the NEF 111g, and one or more network components 114 hosting and/or performing the AF 111h communicatively coupled to one another. In the example of FIG. 7B, the operations 752-798 may be performed by the user equipment 116a, the one or more network components 114 hosting and/or performing the UDSF 111l, the one or more network components 114 hosting and/or performing the AMF 111c, the one or more network components 114 hosting and/or performing the SMF 111i, the one or more network components 114 hosting and/or performing the NEF 111g, and the one or more network components 114 hosting and/or performing the AF 111h.

At operation 752, the UDSF 111l, the AMF 111c, the SMF 111i, the NEF 111g, and the AF 111h may be configured to set up one or more communication operations 103. Herein, the multiple NFs 111 may be set up and/or initiated in accordance with guidance provided in the 3GPP standards. At operation 754, the AF 111h may be configured to a request for providing downlink data 104 from the SCS/AS or external application function 250 to the NEF 111g for the user equipment 116a. At operation 756, the user equipment 116a may be configured to enter an eDRX or MICO mode. At operation 760, the NEF 111g may be configured to perform one or more authorization and control operations. At operation 772, the NEF 111g is configured to transmit a reachability request 132 to the SMF 111i (via the N29 reference point). At operation 774, the SMF 111i is configured to transmit one or more connection signals for the user equipment 116a to the AMF 111c (via the N22 reference point). At operation 786, the AMF 111c and the UDSF 111l are configured to monitor destination availability at the user equipment 116a.

The operation flow 700b may continue at operations 788-798. At operation 788, the AMF 111c is configured to set the UDSF 111l as a centralized storage. At operation 792, the UDSF 111l may be configured to cache downlink data 104 for a predefined period of time and/or until the user equipment 116 changes from a first status 155a to a second status 155b. At operation 790, the user equipment 116a undergoes a status change from a first status 155a to a second status 155b. At operation 796, the user equipment 116a may transmit a registration signal to the AMF 111c indicating that the user equipment 116 changed from the first status 155a to the second status 155b.

The operation flow 700b may conclude at operation 798, where the UDSF 111l and the AMF 111c are configured to provide the cached downlink data 104 to the user equipment 116a.

### Example Process to Dynamically Implement Unified Data Storage Function (UDSF)-Based Data Retrieval for User Equipment in Extended Discontinuous Reception (eDRX) and Mobile Initiated Connection Only (MICO) Modes

FIG. 8 illustrate respective example flowchart of the process 800, in accordance with one or more embodiments. Modifications, additions, or omissions may be made to the process 800. The process 800 may include more, fewer, or other operations than those shown above. For example, operations may be performed in parallel or in any suitable order. While at times discussed as the server 102, one or more of the network components 114, the one or more of the base stations 168, the one or more space components 119, components of any of thereof, or any suitable system or components of the communication system 100 may perform one or more operations of the process 800. For example, one or more operations of the process 800 may be implemented, at least in part, in the form of server instructions 130 of FIG. 1, stored on non-transitory, tangible, machine-readable media (e.g., server memory 128 of FIG. 1 operating as a non-transitory computer-readable medium) that when run by one or more processors (e.g., the server processor 120 of FIG. 1) may cause the one or more processors to perform operations described in operations 802-830.

The process 800 starts at operation 802, where the server 102 may be configured to generate (e.g., communicate) a request 132 to deliver downlink data 104 to one or more user devices (e.g., the user equipment 116) in one or more communication operations 103 over a period of time. At operation 804, the server 102 may be configured to associate the request 132 to deliver the downlink data 104 with the UDSF 111l.

The process 800 continues at operation 810, where the server 102 may determine whether the one or more user devices are unresponsive. In this regard, the server 102 may determine whether a communication link 117a is established between the first network function and the one or more user devices in accordance with one or more access commands 142. If the server 102 determines that the communication link 117a is not established between the first network function and the one or more user devices in accordance with one or more access commands (i.e., NO), the process 800 proceeds to operation 812. If the server 102 determines that the communication link 117a is established between the first network function and the one or more user devices in accordance with one or more access commands (i.e., YES), the process 800 proceeds to operation 822.

The process 800 may conclude at operation 812, where the server 102 is configured to transmit the downlink data 104 to the one or more user devices over the period of time. In response to determining that the communication link 117a is established between the one or more network components hosting the UDSF 111l and the one or more user devices in accordance with the one or more access commands 142, the server 102 is configured to transmit the downlink data 104 to the one or more user devices. The server 102 may determine that a communication link 117a is established if the user equipment 116 provide one or more acknowledgement signals in conjunction with reporting a current status 155.

The process 800 may conclude at operations 822-830. In this case, the server 102 may be configured to at least partially perform one or more of the communication operations 103. At operation 822, the server 102 is configured to cache the downlink data 104 in the UDSF 111l over the period of time. At operation 824, the server 102 is configured to generate an availability request 132 to perform the one or more communication operations 103 with the one or more user devices over an additional period of time. At operation 826, the server 102 is configured to transmit the availability request 132 to the one or more user devices. At operation 828, the server 102 is configured to receive a response from the one or more user devices comprising a connectivity parameter 146 referencing whether the one or more user devices are available to perform the one or more communication operations 103 over the additional period of time. At operation 830, the server 102 is configured to provide a cached version of the downlink data 104 from the UDSF 111l to the one or more user devices in accordance with the one or more communication operations 103.

In some embodiments, the downlink data 104 may comprise comprises mobile terminated (MT) downlink data 104. The process 800 may comprise inhibiting and/or preventing user equipment reachability racing conditions by ensuring timely delivery of MT data from the AMF 111c to the user equipment 116, thereby avoiding situations where the user equipment 116 become unreachable due to latency between the notification of the user equipment reachability and the reception of MT data. The connectivity parameter may be an indicator comprising a CM_connected state.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory operable to store:
one or more access commands comprising guidelines to establish one or more communication links; and
a processor communicatively coupled to the memory and configured to:
communicate a request to deliver downlink data to one or more user devices in one or more communication operations;
associate the request to deliver the downlink data with a unified data storage function (UDSF);
determine whether a communication link is established between one or more network components hosting the UDSF and the one or more user devices based at least in part upon the one or more access commands;
in response to determining that the communication link is not established between the one or more network components hosting the UDSF and the one or more user devices in accordance with the one or more access commands, cache the downlink data in the UDSF; and
in response to determining that the communication link is established between the one or more network components hosting the UDSF and the one or more user devices in accordance with the one or more access commands, transmit the downlink data to the one or more user devices.

2. The apparatus of claim 1, wherein:
the downlink data comprises mobile terminated (MT) downlink data.

3. The apparatus of claim 1, wherein the processor is further configured to:
in conjunction with caching the downlink data in the UDSF, generate an availability request to perform the one or more communication operations with the one or more user devices;
transmit the availability request to the one or more user devices;
receive a response from the one or more user devices comprising a connectivity parameter referencing whether the one or more user devices are available to perform the one or more communication operations; and
in response to receiving the response comprising the connectivity parameter referencing that the one or more user devices are available to perform the one or more communication operations, provide a cached version of the downlink data from the UDSF to the one or more user devices in accordance with the one or more communication operations.

4. The apparatus of claim 3, wherein:
the connectivity parameter references that the one or more user devices are in a CM_connected state.

5. The apparatus of claim 3, wherein:
the processor is further configured to:
generate a report confirming that the cached version of the downlink data is delivered from the one or more network components hosting the UDSF to the one or more user devices in accordance with the one or more communication operations; and
the one or more access commands are guidelines to establish one or more communication links in an extended discontinuous reception (eDRX) mode.

6. The apparatus of claim 3, wherein:
the processor is further configured to:
generate a report confirming that the cached version of the downlink data is delivered from the one or more network components hosting the UDSF to the one or more user devices in accordance with the one or more communication operations; and
the one or more access commands are guidelines to establish one or more communication links in a mobile initiated connection only (MICO) mode.

7. The apparatus of claim 1, wherein:
the one or more user devices configured to perform Internet-of-Things (IoT) operations.

8. A method, comprising:
generating a request to deliver downlink data to one or more user devices in one or more communication operations;
associating the request to deliver the downlink data with a unified data storage function (UDSF);
determining whether a communication link is established between one or more network components hosting the UDSF and the one or more user devices based at least in part upon one or more access commands comprising guidelines to establish one or more communication links;
in response to determining that the communication link is not established between the one or more network components hosting the UDSF and the one or more user devices in accordance with the one or more access commands, caching the downlink data in the UDSF; and
in response to determining that the communication link is established between the one or more network components hosting the UDSF and the one or more user devices in accordance with the one or more access commands, transmitting the downlink data to the one or more user devices.

9. The method of claim 8, wherein:
the downlink data comprises mobile terminated (MT) downlink data.

10. The method of claim 8, further comprising:
in conjunction with caching the downlink data in the UDSF, generating an availability request to perform the one or more communication operations with the one or more user devices;
transmitting the availability request to the one or more user devices;
receiving a response from the one or more user devices comprising a connectivity parameter referencing whether the one or more user devices are available to perform the one or more communication operations; and
in response to receiving the response comprising the connectivity parameter referencing that the one or more user devices are available to perform the one or more communication operations, providing a cached version of the downlink data from the UDSF to the one or more user devices in accordance with the one or more communication operations.

11. The method of claim 10, wherein:
the connectivity parameter is a CM_Connected state information element.

12. The method of claim 10, further comprising:
generating a report confirming that the cached version of the downlink data is delivered from the one or more network components hosting the UDSF to the one or more user devices in accordance with the one or more communication operations, wherein the one or more access commands are guidelines to establish one or more communication links in an extended discontinuous reception (eDRX) mode.

13. The method of claim 10, further comprising:
generating a report confirming that the cached version of the downlink data is delivered from the one or more network components hosting the UDSF to the one or more user devices in accordance with the one or more communication operations, wherein the one or more access commands are guidelines to establish one or more communication links in a mobile initiated connection only (MICO) mode.

14. The method of claim 8, wherein:
the one or more user devices configured to perform Internet-of-Things (IoT) operations.

15. A non-transitory computer-readable medium storing instructions that when executed by a processor cause the processor to:
communicate a request to deliver downlink data to one or more user devices in one or more communication operations;
associate the request to deliver the downlink data with a unified data storage function (UDSF);
determine whether a communication link is established between one or more network components hosting the UDSF and the one or more user devices based at least in part upon one or more access commands comprising guidelines to establish one or more communication links;
in response to determining that the communication link is not established between the one or more network components hosting the UDSF and the one or more user devices in accordance with the one or more access commands, cache the downlink data in the UDSF; and
in response to determining that the communication link is established between the one or more network components hosting the UDSF and the one or more user devices in accordance with the one or more access commands, transmit the downlink data to the one or more user devices.

16. The non-transitory computer-readable medium of claim 15, wherein:
the downlink data comprises mobile terminated (MT) downlink data.

17. The non-transitory computer-readable medium of claim 15, wherein the processor is further caused to:
in conjunction with caching the downlink data in the UDSF, generate an availability request to perform the one or more communication operations with the one or more user devices;
transmit the availability request to the one or more user devices;
receive a response from the one or more user devices comprising a connectivity parameter referencing whether the one or more user devices are available to perform the one or more communication operations; and
in response to receiving the response comprising the connectivity parameter referencing that the one or more user devices are available to perform the one or more communication operations, provide a cached version of the downlink data from the UDSF to the one or more user devices in accordance with the one or more communication operations.

18. The non-transitory computer-readable medium of claim 17, wherein:
the connectivity parameter is a CM_Connected state information element.

19. The non-transitory computer-readable medium of claim 17, wherein the processor is further caused to:
generate a report confirming that the cached version of the downlink data is delivered from the one or more network components hosting the UDSF to the one or more user devices in accordance with the one or more communication operations, wherein the one or more access commands are guidelines to establish one or more communication links in an extended discontinuous reception (eDRX) mode.

20. The non-transitory computer-readable medium of claim 17, wherein:
generate a report confirming that the cached version of the downlink data is delivered from the one or more network components hosting the UDSF to the one or more user devices in accordance with the one or more communication operations, wherein the one or more access commands are guidelines to establish one or more communication links in a mobile initiated connection only (MICO) mode.
